(19) United States
(12) Patent Application Publication
(10) Pub. No.: US 2026/0265613 A1
(43) Pub. Date: Sep. 10, 2026

(54) Method For Producing Fuel Credits

(71) Applicants: Mihaly Istvan Wekler, Houston, TX (US); David Lawrence Whikehart, Houston, TX (US); Taufik Raharjo, Houston, TX (US)

(72) Inventors: Mihaly Istvan Wekler, Houston, TX (US); David Lawrence Whikehart, Houston, TX (US); Taufik Raharjo, Houston, TX (US)

(73) Assignee: Anew Climate, LLC, Houston, TX (US)

(21) Appl. No.: 19/075,475

(22) Filed: Mar. 10, 2025

(51) Int. Cl. C10G 3/00

(52) U.S. Cl. CPC C10G 3/50; C10G 2300/1014; C10G 2300/1025; C10G 2400/04

(57) ABSTRACT

A method for producing one or more low-carbon fuels including reforming a mixture of low-carbon hydrogen and triglyceride feedstock at a fuel production facility and causing a series of chemical reactions to occur in the mixture to produce the one or more low-carbon fuels and generating or causing generation of one or more fuel credits including tracking the low-carbon natural gas through the step of producing the low-carbon hydrogen or tracking the low-carbon hydrogen through the step of producing the one or more low-carbon fuels or both.

### FIELD OF THE INVENTION

This invention relates to low-carbon fuels produced or co-produced at a fuels production facility, including renewable diesel, renewable aviation fuel, renewable naphtha and renewable propane and the like; and a method for making low-carbon fuels and generating fuel credits.

### BACKGROUND

Low-carbon fuel is a fuel that produces fewer greenhouse gas emissions compared to traditional fossil fuels and may be a renewable fuel derived from renewable fuel sources or a low-carbon fuel derived from fossil fuel sources that produce fewer greenhouse gas emissions compared to traditional fossil fuels.

Renewable fuels are fuels that are produced from biogenic or low carbon sources, such as biomass. They can be liquid or gaseous, and can be used for transportation, heating, or jet fuel (also referred to as aviation fuel or renewable aviation fuel or SAF (sustainable aviation fuel)). Renewable fuels are a sustainable alternative to non-renewable resources like fossil fuels such as petroleum and coal and can help reduce greenhouse gas (GHG) emissions. Some examples of renewable fuels include renewable natural gas (RNG), renewable hydrogen, renewable ethanol, renewable gasoline, renewable diesel, and sustainable aviation fuel. Renewable fuels include biofuels, which are primarily produced from renewable biomass. Bioliquids are liquid biofuels produced at renewable fuels production facilities. Biofuels are usually used for on-road and off-road transportation, aviation, the fueling of maritime vessels or heating fuel, but may also be used to produce energy used for purposes other than transport and heating fuel.

Low-carbon fuel derived from fossil fuel sources include fuels derived from low-carbon fossil natural gas such as but not limited to vented geologic natural gas, CCS-enabled natural gas, diverted flared natural gas, or the like, or a combination thereof. Geologic natural gas is a naturally occurring mixture of hydrocarbon gases, primarily methane, found in underground geological formations beneath the Earth's surface, formed through the decomposition of organic matter, and some of this is naturally vented. Capturing this vented natural gas that otherwise would enter the atmosphere and converting it to a usable fuel reduces greenhouse gas emissions. CCS-enabled natural gas is natural gas that is collected or processed or transported in a manner that includes capturing the greenhouse gases that would be emitted through such collection, processing or transportation and permanently preventing their release to atmosphere via underground geologic storage, chemical conversion, or other means. Natural gas that vents from oil production fields is often flared (combusted) without producing useful energy and diverting this otherwise flared natural gas to beneficial use instead of flaring it also reduces greenhouse gas emissions.

Various governments including at least the U.S., U.K, and other European countries promote the use of renewable fuels through different programs to promote displacement of fossil fuels for energy security, economic development and GHG reduction. The U.S. Environmental Protection Agency (EPA) administers the Renewable Fuel Standard (RFS) program, which sets volume requirements for renewable fuels. The EPA tracks compliance through the Renewable Identification Number (RIN) system.

Some renewable fuels such as ethanol, RNG, and hydrogen have limitations or drawbacks when used directly as a fuel. Production of ethanol often uses human and animal food products and those uses tend to drive the price of human food up. Direct use of RNG as a transportation fuel has limited uses because there is a lack of transportation fueling infrastructure for RNG and natural gas fueled vehicles, whereas there is plentiful infrastructure designed for gasoline or diesel fuels use already in place. Direct use of hydrogen as a transportation fuel is not adopted widely and several technical, safety and economic challenges remain.

Despite considerable efforts to commercialize low-carbon fuels effectively relative to traditional fossil fuels, there remains a need to do so with more precision, especially with transportation and heating fuels.

### BRIEF SUMMARY

Provided herein are low-carbon fuel compositions including renewable diesel and methods for making low-carbon fuels and generating fuel credits. A method for producing one or more low-carbon fuels is disclosed, the method comprising the steps of providing low-carbon natural gas at a fuel production facility; subjecting the low-carbon natural gas at the fuel production facility to a reforming process that produces low-carbon hydrogen; combining the low-carbon hydrogen with triglyceride feedstock at the fuel production facility to form a mixture and causing a series of chemical reactions to occur in the mixture so as to produce the one or more low-carbon fuels; and generating or causing generation of one or more fuel credits including tracking the low-carbon natural gas through the step of producing the low-carbon hydrogen or tracking the low-carbon hydrogen through the step of producing the one or more low-carbon fuels or both. This method presents the opportunity to displace fossil natural gas with low-carbon natural gas and thereby generate fuel credits.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 depicts a schematic overview of a method for making renewable diesel and other renewable fuels according to an embodiment of the present invention.

FIG. 2 depicts a schematic overview of a method for making sustainable aviation fuel and other renewable fuels according to an embodiment of the present invention.

FIG. 3 depicts a schematic overview of a method for generating fuel credits according to an embodiment of the present invention.

FIG. 4 depicts a schematic overview of a hydroprocessing model according to an embodiment of the present invention.

FIG. 5 depicts a schematic overview of a steam methane reforming model according to an embodiment of the present invention.

FIG. 6 depicts a schematic overview of a hydrogen tracker according to an embodiment of the present invention.

FIG. 7 depicts a schematic overview of a simple hydrogen flow according to an embodiment of the present invention.

FIG. 8 depicts a schematic overview of a detailed hydrogen flow tracking according to an embodiment of the present invention.

FIG. 9 depicts a schematic overview of a general process flow diagram according to an embodiment of the present invention.

FIG. 10 depicts a schematic overview of a fuel credit generation model according to an embodiment of the present invention.

FIG. 11 depicts a schematic overview of a general process flow diagram according to an embodiment of the present invention.

FIG. 12 depicts a schematic overview of a detailed system balance according to an embodiment of the present invention.

### DETAILED DESCRIPTION

Embodiments of the present invention described herein include low-carbon fuel compositions including low-carbon fuels and methods for making low-carbon fuels and generating fuel credits. According to an embodiment of the present invention, a method for producing a low-carbon fuel comprises the steps of providing low-carbon natural gas at a fuel production facility or a hydrogen production facility supplying hydrogen to a fuel production facility; subjecting the low-carbon natural gas at the fuel production facility or hydrogen production facility to a reforming process that produces low-carbon hydrogen; combining the low-carbon hydrogen with triglyceride feedstock at the fuel production facility to form a mixture and causing a series of chemical reactions to occur in the mixture so as to produce the low-carbon fuel; and generating or causing generation of a fuel credit including tracking the low-carbon natural gas through the step of producing the low-carbon hydrogen or tracking the low-carbon hydrogen through the step of producing the one or more low-carbon fuels or both. Low-carbon hydrogen as used herein means hydrogen produced by subjecting low-carbon natural gas to a reforming process. Renewable hydrogen as used herein means hydrogen produced by subjecting renewable natural gas to a reforming process. Low-carbon fuel is a fuel that produces fewer greenhouse gas emissions compared to traditional fossil fuels and may be a renewable fuel derived from renewable fuel sources or a low-carbon fuel derived from fossil fuel sources that produce fewer greenhouse gas emissions compared to traditional fossil fuels.

At least some embodiments of this invention present the opportunity to displace fossil natural gas with low-carbon natural gas and thereby generate fuel credits. Low-carbon natural gas used in at least some embodiments of this invention can be renewable natural gas derived from renewable sources and some can be derived from low carbon fossil fuel sources that produce fewer greenhouse gas emissions compared to traditional fossil fuels such as but not limited to vented geologic natural gas, CCS-enabled natural gas, diverted flared natural gas, or the like, or a combination thereof. According to embodiments of this invention, fuel credits generated or caused to be generated include fuel credits enabled by any programs that allow or employ incentives or avoid disincentives, including but not limited to monetary incentives and disincentives, based on the quantification of low-carbon fuel production. Examples of such currently existing fuel credit programs include the United States Renewable Fuel Standard including Renewable Identification Numbers (RINs), the United States 45Z Clean Fuels Production Tax Credit, the California Low Carbon Fuel Standard (LCFS), the Oregon Clean Fuels Program, the Washington Clean Fuel Standard, the Canada Clean Fuel Regulations, the United Kingdom's Renewable Transport Fuel Obligation as well as other national renewable fuels programs implemented in various European Union Member States pursuant to the European Commission's Renewable Energy Directive and Fuel Quality Directive as amended, supplemented or restated from time to time.

At least some embodiments of this invention produce a proportion of renewable fuels derived from renewable sources and furthermore allow for the precise tracking of low-carbon hydrogen through the low-carbon fuel production process and then determination of the portion of low-carbon fuels derived from such low-carbon hydrogen due to displacement of fossil natural gas with low-carbon natural gas to produce low-carbon hydrogen. At least some embodiments of this invention produce a proportion of renewable fuels derived from certain types of biomass such as cellulosic renewable biomass and furthermore allow for the precise tracking of low-carbon hydrogen through the renewable fuel production process and then determination of the portion of low-carbon fuels derived from certain sources of biomass, such as cellulose, hemicellulose, lignin, or a combination thereof, due to displacement of fossil natural gas with renewable natural gas in the production of low-carbon hydrogen. Embodiments of this invention are not limited to the characteristics of any one fuel production process used in low-carbon fuel production facilities but instead can be calibrated to model a wide range of triglyceride feedstocks, reaction pathways involved in low-carbon fuel production as well as gas reforming processes and efficiencies.

Low-Carbon Fuel Compositions and Methods for Making them

Generally, according to embodiments of the present invention, methods for producing a low-carbon fuel include creating a mixture of low-carbon hydrogen and triglyceride feedstock at a fuel production facility and causing a series of chemical reactions to occur in the mixture so as to produce the low-carbon fuel and generating or causing generation of a fuel credit including tracking the low-carbon natural gas through the step of producing the low-carbon hydrogen or tracking the low-carbon hydrogen through the step of producing the one or more low-carbon fuels or both. Low-carbon fuels made according to embodiments of the present invention include renewable fuels such as renewable diesel fuel, sustainable aviation fuel, and the like. Although the embodiments described below describe production of renewable fuels with renewable natural gas, the renewable natural gas may be substituted with low-carbon fossil natural gas derived from low carbon fossil fuel sources that produce fewer greenhouse gas emissions compared to traditional fossil fuels.

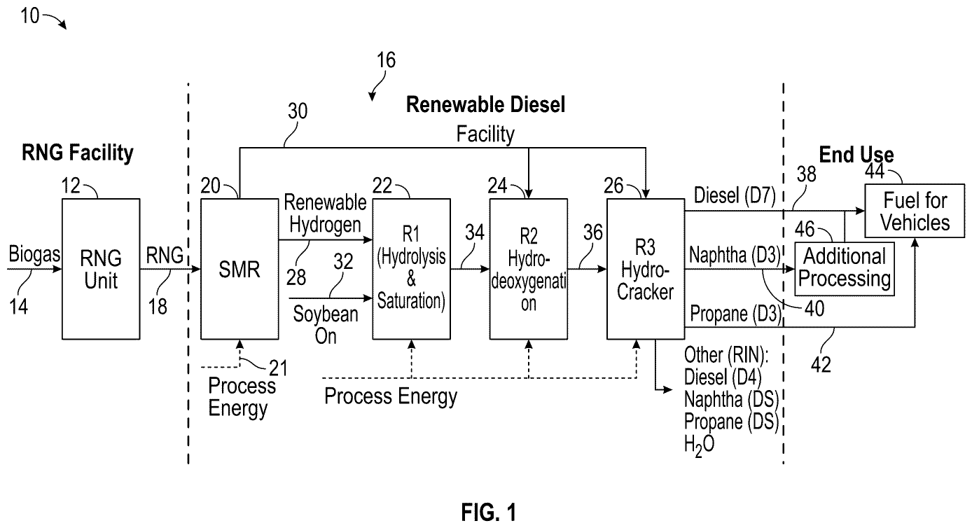

FIG. 1 provides an overview of a system 10 for making and using renewable diesel fuel according to an embodiment of this invention including a renewable natural gas (RNG) unit 12 which receives a biogas stream through a conduit 14 from a biomass source (not shown) and a renewable diesel fuel production facility 16 which receives the RNG via a conduit 18. The diesel fuel production facility 16 includes a reforming unit 20, a hydrolysis and saturation unit 22, a hydrodeoxygenation unit 24, and a hydrocracker 26. The reforming unit 20 receives the RNG feedstock via the conduit 18 and may also receive RNG process energy 21. The reforming unit 20 produces renewable hydrogen which is released via conduits 28 and 30. The hydrolysis and saturation unit 22 receives triglycerides such as soybean oil via conduit 32. Other sources of triglycerides may be used such as vegetable oil including, in addition to soybean oil, corn oil, sorghum oil, camelina Sativa oil, canola oil, rapeseed oil and other seed oils, oil from annual cover crops, oil from algae, biogenic waste oils, used cooking oil, fats, and greases, and the like. The hydrolysis and saturation unit 22 converts the triglycerides to unsaturated fatty acids via hydrolysis and reacts the unsaturated fatty acids with the low-carbon hydrogen to produce saturated fatty acids which are released via conduit 34. Propane may also be produced in the hydrolysis and saturation unit 22 and be released directly into conduit 42.

The conduit 34 feeds the saturated fatty acids to the hydrodeoxygenation unit 24 for additional hydroprocessing. The reforming unit 20 feeds additional renewable hydrogen to the hydrodeoxygenation unit 24 and the saturated fatty acids and hydrogen react in the hydrodeoxygenation unit 24 to produce heavy alkanes which are released from the hydrodeoxygenation unit 24 vis conduit 36.

The hydrocracker 26 receives the renewable hydrogen from the reforming unit 20 via conduit 30 and alkanes from the hydrodeoxygenation unit 24 via conduit 36 and the heavy alkanes and hydrogen are reacted in the hydrocracker 26 to produce renewable diesel, naphtha, and propane. The hydrocracker 26 releases the renewable diesel, naphtha, propane via conduits 38, 40, and 42, respectively. The renewable diesel and propane may be used directly as fuel for vehicles as shown at 44 and the naphtha, after further processing, may be used as a blend-stock for gasoline.

According to embodiments of this invention, the biogas delivered by conduit 14 to the RNG unit 12 may be sourced from a variety of sources that capture methane from the anaerobic decomposition of renewable biomass including landfills, anaerobic digesters, municipal wastewater treatment facility digesters, agricultural digesters, municipal solid waste digesters, cellulosic biomass processed in digesters, and the like. Biomass may be described as renewable organic material that comes from plants and animals. According to embodiments of this invention, biomass may be sourced for example from crop residue, slash, pre-commercial thinnings and tree residue, switchgrass, Miscanthus, energy cane, Arundo donax, Pennisetum purpureum, separated yard waste, municipal solid waste, separated food waste, cellulosic components of annual cover crops, and the like.

RNG is biogas that originates from biogenic feedstock and has been upgraded to common carrier pipeline quality and the RNG unit 12 processes the biogas from conduit 14 according to well-known processes for producing RNG which is released from the RNG unit 12 via conduit 18. According to an embodiment of this invention, suitable RNG includes but is not limited to RNG currently meeting the qualifications specified in row Q of Table 1 to 40 CFR 80.1426 for CNG/LNG production, as approved by the EPA. RNG is a pipeline-quality gas that is fully interchangeable with conventional natural gas, and therefore, according to an embodiment of this invention, RNG may be processed in fuel production without requiring any additional construction to existing renewable fuel production facilities.

The reforming unit 20 at the renewable fuel production facility 16 receives the RNG via conduit 18 and uses water to convert the RNG to hydrogen and carbon dioxide. RNG delivery to the reforming unit (depicted as conduit 18) may happen as an immediate physical flow of RNG molecules from RNG unit 12 to reforming unit 20, but more often RNG delivery may occur by attributing quantities of RNG injected into the common carrier pipeline system to corresponding quantities of gas withdrawn from an interconnected part of the common carrier pipeline system. When RNG delivery occurs via attribution, it is not the same molecules of RNG that are produced by RNG unit 12 which are used for hydrogen production in reforming unit 20, instead a corresponding quantity of natural gas from the common carrier pipeline system is displaced because RNG is chemically interchangeable with natural gas and is fully comingled with natural gas following injection into the common carrier pipeline system. Embodiments of this invention may be used to generate or cause the generation of renewable fuel credits including attribution-based delivery of RNG through the common carrier pipeline system.

According to embodiments of this invention, the reforming unit 20 may produce hydrogen with a known reforming process such as steam methane reforming or an autothermal reforming. In the embodiment shown in FIG. 1, the reforming unit 20 uses steam methane reforming (SMR) to produce hydrogen. SMR is a known chemical process designed for large-scale hydrogen production, involving two chemical reactions that ultimately convert water and natural gas into pure hydrogen and carbon dioxide. SMR is disclosed, for example, in U.S. Pat. Nos. 6,749,829; 8,409,307; 9,206,360; 9,328,291; the disclosures of which are hereby incorporated herein by reference in their entirety. Autothermal reforming (ATR) and water gas shift reactions may also be used to produce renewable hydrogen from RNG.

Both ATR and SMR operate by exposing the combustible fluid feedstock or methane therein to a catalyst at high temperature and pressure to produce syngas, which is low-carbon hydrogen and carbon monoxide. The carbon monoxide generated by either method may be generally further reacted with water in a water gas shift reaction to form carbon dioxide and low-carbon hydrogen. SMR converts the methane into low-carbon hydrogen and carbon monoxide without oxygen. The carbon monoxide reacts further to produce more low-carbon hydrogen in the water gas shift reaction. The relevant equations are as follows:

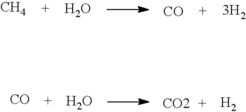

The overall SMR is as follows:

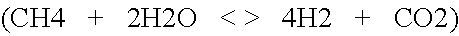

Without being limiting, conventional steam reforming plants may operate at pressures between 200 and 600 psi with outlet temperatures in the range of 815 to 925° C.

ATR uses oxygen and carbon dioxide or steam in a reaction with methane to form syngas and water. The reaction may take place in a single chamber where the methane is partially oxidized. The reaction is exothermic due to the oxidation. The reactions can be described in the following equations, using CO₂:

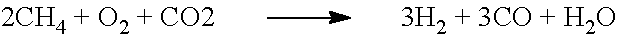

and using steam

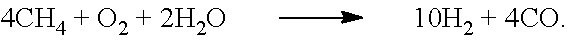

SMR and ATR are carried out in any suitable device or devices for producing low-carbon hydrogen from a combustible fluid feedstock and include devices and operations that are known or used in the art for such purposes. The steam reforming operation may be situated in the diesel fuel production facility or the operation may be a separate plant located off-site.

It is preferred that the low-carbon hydrogen produced by SMR or ATR be purified to remove one or more non-hydrogen components. The low-carbon hydrogen may be purified by methods known to those skilled in the art, such as liquid absorption system for carbon dioxide removal or a pressure swing absorption operation to produce a purified low-carbon hydrogen product.

According to an embodiment of this invention, the hydrocracker 26, via known refining methods, converts heavy hydrocarbons into lighter, more valuable products, in this case, renewable diesel, naphtha (light naphtha and heavy naphtha), and propane. According to an embodiment of the present invention, the time period required to complete the reforming process and the process for combining the low-carbon hydrogen with triglyceride feedstock at the renewable fuel production facility to form a mixture and causing the series of chemical reactions to occur in the mixture so as to produce the renewable fuel is a batching period.

Hydrocracking with hydrogen to produce diesel fuel is disclosed, for example, in U.S. Pat. No. 11,091,706; the disclosure of which are hereby incorporated herein by reference in its entirety.

The hydrocracking process includes subjecting the mixture of alkanes and low-carbon hydrogen to a series of hydrocracking catalysts such as zeolites, inorganic oxides, and hydrogenation metals such as Group VIII metals (nickel or cobalt) or Group VI metals (molybdenum or tungsten) or Group X metals (palladium).

According to embodiments of this invention, renewable diesel fuel produced would be suitable for use in diesel engines and meeting both the EPA definitions of cellulosic biofuel and biomass-based diesel. The renewable cellulosic diesel also can be used as heating oil. According to embodiments of this invention, after further processing, the renewable naphtha produced would be a blend-stock or fuel blending component used to produce neat gasoline or blends of gasoline and ethanol at various blend levels.

In system 10, throughout the production of renewable hydrogen from RNG and subsequent renewable fuel production including such renewable hydrogen, the renewable hydrogen becomes an integral part of the renewable diesel, naphtha and propane produced, thereby qualifying a portion of these fuels as renewable cellulosic fuels or fuel blend-stocks that may qualify for the generation of certain renewable fuel credits.

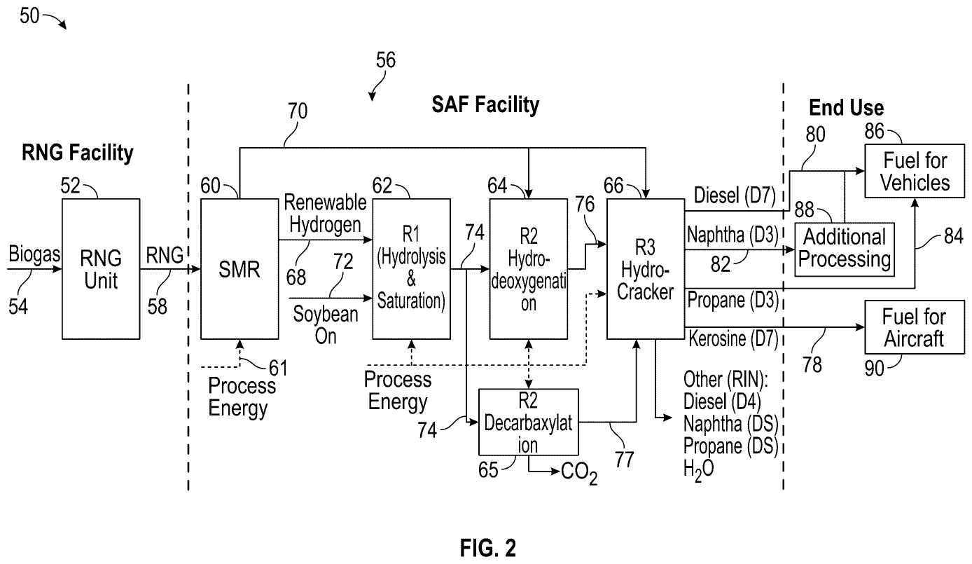

FIG. 2 provides an overview of a system 50 for making and using sustainable aviation fuel in addition to renewable diesel fuel according to an embodiment of this invention including a renewable natural gas (RNG) unit 52 which receives a biogas stream through a conduit 54 from a biomass source (not shown) and a sustainable aviation fuel production facility 56 which receives the RNG via a conduit 58. The sustainable aviation fuel production facility 56 includes a reforming unit 60, a hydrolysis and saturation unit 62, a hydrodeoxygenation unit 64, a decarboxylation unit 65, and a hydrocracker 66. The reforming unit 60 receives the RNG feedstock via the conduit 58 and may also receive RNG process energy 61. The reforming unit 60 produces renewable hydrogen which is released via conduits 68 and 70. The hydrolysis and saturation unit 62 receives triglycerides such as soybean oil via conduit 72. Other sources of triglycerides may be used such as corn oil, sorghum oil, camelina Sativa oil, canola oil, rapeseed oil, oil from annual cover crops, oil from algae, biogenic waste oils, fats, and greases, and the like. The hydrolysis and saturation unit 62 converts the triglycerides to unsaturated fatty acids vis hydrolysis and reacts the unsaturated fatty acids with the renewable hydrogen to produce saturated fatty acids which are released via conduit 74. Propane may also be produced in the hydrolysis and saturation unit 62 and be released directly into conduit 84.

The conduit 74 feeds the saturated fatty acids to the hydrodeoxygenation unit 64 and the decarboxylation unit 65 for additional processing. The reforming unit 60 feeds additional renewable hydrogen via conduit 70 to the hydrodeoxygenation unit 64 and the saturated fatty acids and hydrogen react in the hydrodeoxygenation unit 64 to produce heavy alkanes which are released from the hydrodeoxygenation unit 64 via conduit 76. Meanwhile, the decarboxylation unit 65 receives saturated fatty acids via conduit 74 and a portion of the saturated fatty acids from the hydrolysis and saturation unit 62 are reacted in the decarboxylation unit 65 to produce heavy alkanes which are released from the decarboxylation unit 65 via conduit 77.

The hydrocracker 66 receives the renewable hydrogen from the reforming unit 60 via conduit 70 and alkanes from the hydrodeoxygenation unit 64 via conduit 76 and the decarboxylation unit 65 via conduit 77 and the alkanes and hydrogen are reacted in the hydrocracker 66 to produce renewable kerosine, diesel, naphtha, and propane. The hydrocracker 66 releases the renewable kerosine, diesel, naphtha, propane via conduits 78, 80, 82, and 84, respectively. The renewable diesel and propane may be used directly as fuel for vehicles as shown at 86, the naphtha may be used as blend-stock for gasoline as shown at 88, and the kerosine may be used as fuel for aircraft as shown at 90.

### Generation of Fuel Credits

As explained above, according to embodiments of this invention, the low-carbon fuels may be used directly as fuel for vehicles, such as renewable diesel for automobiles, and sustainable aviation fuel for aircraft, and the light naphtha and heavy naphtha may be used as blend-stocks for gasoline. The renewable cellulosic diesel is a renewable fuel suitable for use in diesel engines and meeting both the EPA definitions of cellulosic biofuel and biomass-based diesel for fuel credits. Fuel credits such as RINs are generated for the portion of the final renewable diesel, naphtha and propane (renewable fuels) derived from RNG-based hydrogen and delivered into the transportation fuel market. Qualification of embodiments of the present invention for generating fuel credits, such as for example, D7 RINs for cellulosic diesel and D3 RINs for naphtha and propane, would open up new opportunities for utilizing RNG within the petroleum industry and create synergies with existing state and federal fuel decarbonization programs.

According to at least some embodiments of the invention, the step of generating or causing generation of one or more fuel credits comprises tracking the renewable natural gas through the step of producing the renewable hydrogen. According to at least some embodiments of the invention, the step of generating or causing generation of one or more fuel credits comprises tracking the renewable hydrogen through the step of producing the one or more renewable fuels. According to at least some embodiments of the invention, the step of producing the one or more renewable fuels produces a proportion of total renewable fuels derived from different renewable sources produced at the renewable fuel production facility and the step of generating or causing generation of one or more fuel credits comprises tracking the renewable hydrogen through the step of producing the one or more renewable fuels and determining the proportion of the total renewable fuels derived from different renewable sources due to displacement of fossil natural gas with the renewable natural gas. And according to at least some embodiments of the invention, the step of producing the one or more renewable fuels produces a proportion of total renewable fuels derived from one or more types of biomass produced at the renewable fuel production facility and the step of generating or causing generation of one or more fuel credits comprises tracking the renewable hydrogen through the step of producing the one or more renewable fuels and determining the proportion of the total renewable fuels derived from the one or more types of biomass due to displacement of fossil natural gas with the renewable natural gas.

According to at least some embodiments of the invention, the step of generating or causing generation of a fuel credit comprises generating numerical information associated with the one or more fuel credits. According to at least some embodiments of the invention, the one or more fuel credits are enabled by any program that allows or employs incentives or avoids disincentives based on the quantification of renewable fuel production. According to at least some embodiments of the invention, the one or more fuel credits include a Renewable Identification Number (RIN). According to at least some embodiments of the invention, the one or more fuel credits includes a California Low Carbon Fuel Standard (LCFS) credit. According to at least some embodiments of the invention, the one or more renewable fuels produced from the renewable natural gas that is subjected to reforming generates one or more RINs. According to at least some embodiments of the invention, generation of the one or more RINs is based on retirement of Cellulosic Biofuel RINs that are generated and assigned to renewable natural gas at production of the renewable natural gas that is subsequently subjected to reforming. According to at least some embodiments of the invention, producing the one or more renewable fuels generates one or more cellulosic RINs.

According to at least some embodiments of the invention, the fuel credit is a Renewable Identification Number (RIN) and producing the renewable diesel fuel, naphtha and propane with the renewable hydrogen generates one or more cellulosic RINs. According to at least some embodiments of the invention, the fuel credit is a Renewable Identification Number (RIN) and producing the sustainable aviation fuel generates one or more cellulosic RINs.

According to at least some embodiments of the invention, the number of RINs for every renewable fuel is calculated by determining the equivalence value used for each renewable fuel and the volume of each renewable fuel and multiplying the equivalence value used for each renewable fuel by the volume of each renewable fuel.

RIN generation for embodiments of the present invention are based on generation of Cellulosic Biofuel RINs that are assigned to RNG at production and injection into a pipeline (“RNG-RINs”) and delivery to the renewable fuel production facility or renewable fuels production facility and then retirement of such RNG-RINs received by a refiner.

Batching of RINs for renewable fuels production from RNG feedstock may occur monthly, in alignment with RNG-RIN generation at the renewable fuel production facility and conveyance timelines.

The renewable fuels production facility will report the quantity of renewable fuels produced in each batch based on the amount of RNG used from their RNG-RIN inventory and their monitored operational parameters during the batching period.

Below, a list of monitored operational parameters at the renewable fuels production facility is provided, alongside the calculation used to determine the number of RINs (V_{RIN}) for each type of renewable fuel produced.

For every renewable fuel (i), the number of RINs is calculated as:

$${V}_{RIN , i} = {EqV}_{i} * {V}_{s , i}$$

wherein,
the steps of subjecting the renewable natural gas to reforming to produce renewable hydrogen and combining the renewable hydrogen with triglyceride feedstock at the renewable fuel production facility to form a mixture and causing a series of chemical reactions to occur in the mixture so as to produce one or more renewable fuels occurs over a batching period;
i is each type of renewable fuel that RINs are generated for respective ones of the one or more renewable fuels;
V_{RIN,i} is the number RINs to be generated for each of the one or more renewable fuels;
E_{q}Vᵢ is the equivalence value used for each of the one or more renewable fuels (Equivalence Value is the EPA-assigned conversion factor, codified in CFR 40. 80.1115, which equates how many gallon RINs are generated per gallon of corresponding renewable fuel):
   diesel: 1.7
   naphtha (heavy fractions): 1.5
   naphtha (light fractions): 1.4
   propane: 1.1;
   kerosine: 1.6.
V_{s,i} is the volume of each of the one or more renewable fuels, calculated as follows:

$${V}_{s , i} = {V}_{H 2 - derived , gal , i} \times \frac{{RNG\_Used}_{MMBtu}}{SMR\_Ratio \times {H}_{2} \_to {\_RDF}_{MMBtu} \times {\%}_{H 2 toFuels}}$$

wherein,
RNG_Used_{MMBtu} is the renewable natural gas provided and subjected to reforming to produce renewable hydrogen in the batching period, in MMBtu and as established through RNG-RIN retirement;
SMR_Ratio is the overall MMBtu of the renewable natural gas entering the reforming process divided by the overall MMBtu of renewable hydrogen gas product leaving the reforming process used to produce renewable hydrogen for combining with the triglyceride feedstock in the renewable fuel facility, in the batching period;
H₂_to_RDF_{MMBtu} is the total MMBtu of renewable hydrogen that was introduced to the renewable fuel facility in the batching period;
%_{H2toFuels} is the portion of the renewable hydrogen, measured as a percentage of H₂_to_RDF_{MMBtu} that is embedded into the one or more renewable fuels;
V_{H2-derived,gal,i} is the gallons of each fuel derived from hydrogen, calculated as follows:

$${V}_{H 2 - derived , gal , i} = {Total\_vol}_{S , i} \times \frac{{MMBtu}_{H 2 - derived , i}}{{MMBtu}_{Trigly . - derived , i} + {MMBtu}_{H 2 - derived , i}}$$

Total_vol_{S,i} is the measured aggregate standardized volume at 60° F., in gallons, of each of the one or more renewable fuels i produced at the renewable fuel facility during the batching period;
MMBtu_{H2-derived,i} is the total energy content, on a lower heating value basis, of the one or more renewable fuels i produced by the renewable fuel facility during the batching period that is derived from the renewable hydrogen; and
MMBtu_{Trigly.-derived,i} is the total energy content, on a lower heating value basis, of the one or more renewable fuels i produced by the renewable fuel facility during the batching period that is derived from the triglyceride feedstock.

The calculation of factors MMBtu_{H2-derived,i}, MMBtu_{Trigly.-derived,i} and %_{H2toFuels} is the result of in-depth modeling of the renewable fuel facility's operations that, amongst other inputs takes into account the fatty acid chain composition of the facility's feedstock in the batching period, the hydroprocessing steps and specific reaction paths taken by the renewable fuels production facility. The Examples provided herein provide a more in-depth description of this modeling. The operational specifics of the renewable fuel facility for each batching period is used in accordance with the Examples described herein to yield batch-specific MMBtu_{H2-derived,i}, MMBtu_{Trigly.-derived,i} and %_{H2toFuels} factors.

According to at least some embodiments of the invention, values for %_{H2toFuels}, MMBtu_{H2-derived,i} and MMBtu_{Trigly.-derived,i} are established through tracking molecules of the renewable hydrogen throughout the steps of subjecting the renewable natural gas to the reforming process and producing one or more renewable fuels.

According to at least some embodiments of the invention, a total quantity of natural gas is subjected to the reforming process and the renewable natural gas subjected to reforming is provided at a quantity that may be equal to or less than the total quantity of natural gas subjected to the reforming process.

Embodiments of this invention may generate fuel credits not only those recognized by the U.S. government, but also those recognized by the governments of other countries or by private contract. Generally, renewable fuel credit means any rights, credits, revenues, offsets, greenhouse gas rights, rights to any greenhouse gas emission reductions, carbon-related credits or equivalent arising from emission reduction trading or any quantifiable benefits (including recognition, award or allocation of credits, allowances, permits or other tangible rights), whether created from or through a governmental authority or a private contract. According to an embodiment of the invention, the renewable fuel credit is a certificate, record, serial number or guarantee, in any form, including electronic, which evidences production of a quantity of fuel meeting certain lifecycle GHG emission reductions relative to a baseline set by a government authority.

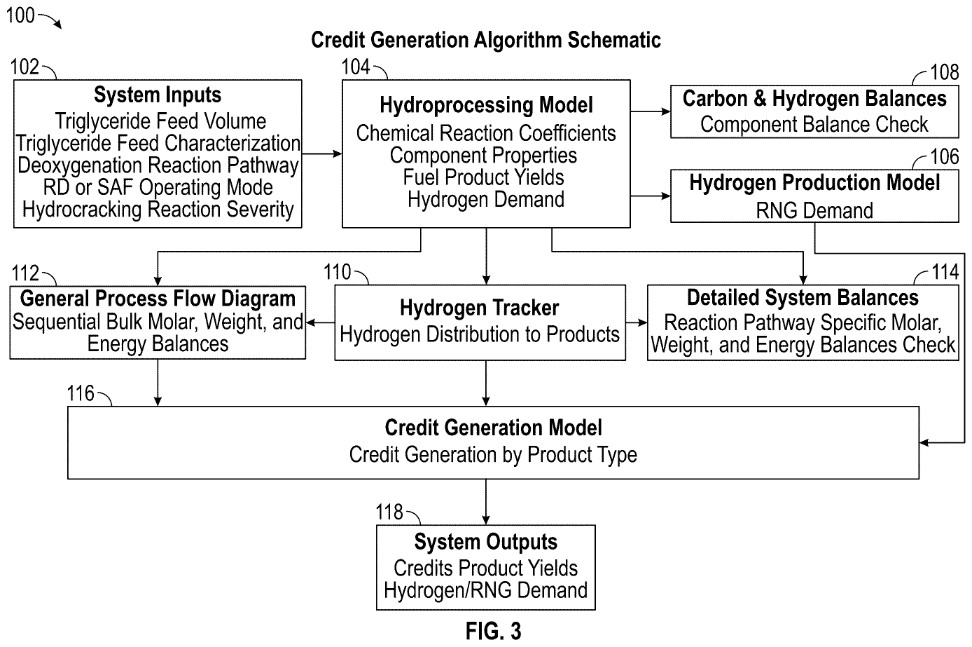

A renewable fuel credit algorithm and generation model is described below and illustrated in FIGS. 3-12.

FIG. 3 is a Credit Generation Algorithm Schematic 100 according to an embodiment of this invention and illustrates the data flow through multiple spreadsheet models resulting in the calculation of environmental attribute credits for renewable fuel products. A limited number of System Inputs 102, shown in Table 1, are required to prime the algorithm to complete the credit calculations. These inputs include the Triglyceride Feed Characterization and Volume, Deoxygenation Reaction Pathway mix, Renewable Diesel (RD) or Sustainable Aviation Fuel (SAF) Operating Mode, and Hydrocracking Reaction Severity.

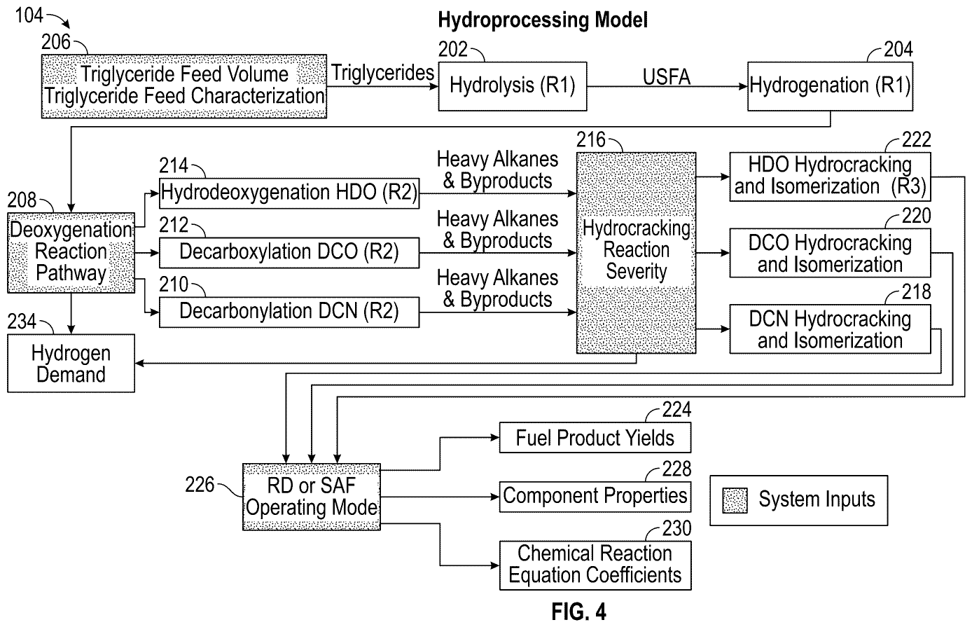

The System Inputs 102 flow into the Hydroprocessing Model 104, shown in more detail in FIG. 4, where a three-step sequential progression of hydroprocessing chemical reactions are employed to generate Fuel Product and Byproduct quantity yields as well as the quantity of hydrogen required to complete the hydroprocessing reactions (the Hydrogen Demand). Physical properties of the components formed by the hydroprocessing reactions are also calculated (Component Properties).

The Hydrogen Demand data flows to the Hydrogen Production Model 106 where a chemical conversion process, called a Steam Methane Reformer (SMR), is represented. The SMR process converts methane, the primary component in Renewable Natural Gas, into hydrogen. This model calculates the quantity of Renewable Natural Gas SMR feedstock required to meet the Hydrogen Demand as calculated by the Hydroprocessing Model 104.

The outputs of the Hydroprocessing Model 104 are used to calculate material balances like Carbon & Hydrogen Balances 108 for all of the carbon and hydrogen molecules used in chemically converting the Triglyceride Feed into Fuel Products. These balances provide a check that all of the System Input carbon and hydrogen molecules are accounted for throughout the Hydroprocessing Model 104.

The Hydroprocessing Model 104 output data flows to the Hydrogen Tracker 108 where all of the hydrogen sources (Triglycerides and SMR) and uses (Hydroprocessing Model chemical reactions) are accounted for in detail to determine the specific hydrogen sources for each Fuel Product and Byproduct.

The Hydroprocessing Model 104 output is combined with the Hydrogen Tracker 110 output to develop a General Process Flow Diagram 112 that provides sufficient detail on the three-step sequential progression of the hydroprocessing chemical reactions to allow for material and energy balances on each of the three sequential reaction steps. Detailed System Balances 114 like Energy and Material balances are also developed for the total hydroprocessing chemical reaction process.

The Hydroprocessing Model 104 output is combined with the Hydrogen Tracker 110 output to develop detailed molar, weight, and energy balances for each of the three reaction steps. These balances provide a check that all of the System Input 102 material and energy is accounted for in the Fuel Products and Byproducts.

The outputs from the General Process Flow Diagram and the Hydrogen Tracker are used as inputs to the Credit Generation Model 116 to calculate System Outputs 118 such as the quantity and type of environmental attribute credits generated by the total hydroprocessing chemical reaction process that converts Triglycerides into Fuel Products.

As set forth in Table 1, the System Inputs 102 start with the Triglyceride Feed Characterization and Volume. The Feed Characterization identifies the triglyceride types and their molar percentage of the feed. The Volume is measured in gallons.

The Deoxygenation Reaction Pathway mix is the share of each pathway used in the hydroprocessing chemical reaction process, in percent. There are three reaction pathways: Decarbonylation (DCN), Decarboxylation (DCO), and Hydrodeoxygenation (HDO). Each reaction pathway yields a different mix of reaction products and byproducts.

The model incorporates logic used to differentiate the primary fuel product between Renewable Diesel (RD) or Sustainable Aviation Fuel (SAF). In RD Operating Mode, RD is the primary fuel product by volume with lesser volumes of naphtha and propane Fuel Product yielded. In SAF Operating Mode, SAF is the primary Fuel Product by volume with lesser volumes yielded of RD, Naphtha, and Propane Fuel Product.

Hydrocracking Reaction Severity has two components: Hydrocracking Reaction Extent and Propane Hydrocracking. The Hydrocracking Reaction Extent is the percentage of hydrocracker feed that is actually cracked to lighter molecular weight Fuel Products. The remaining hydrocracker feed that is not cracked passes through the reactor chemically unchanged. Propane Hydrocracking is the percentage of hydrocracked material that converts to Propane Fuel Product. The remaining hydrocracked material forms Naphtha and Kerosine Fuel Products.

TABLE 1

| Parameter | Description/Units |
|---|---|
| Triglyceride Feed Volume | Gallons |
| Triglyceride Feed Characterization | lb-mol % of each |
| Tripalmitin | Triglyceride Feed Type |
| Tripalmitolein | Totaling 100% |
| Stearin | |
| Trioelin | |
| Linolein | |
| Triliolenin | |
| Deoxygenation Reaction Pathway | lb-mol % of Saturated |
| Hydrodeoxygenation (HDO) | Fatty Acids for Each Pathway |
| Decarboxylation (DCO) | Totaling 100% |
| Decarbonylation (DCN) | |
| Operating Mode | Primary Fuel Product Choice |
| Renewable Diesel (RD) | |
| Sustainable Aviation Fuel (SAF) | |
| Hydrocracker Reaction Severity | lb-mol % of Heavy Alkanes |
| Hydrocracking Reaction Extent | Subject to the Hydrocracking |
| Propane Hydrocracking | Reaction Process and Further |
| | Propane Hydrocracking |

The Hydroprocessing Model 104, shown in more detail in FIG. 4 with supporting information in Table 2, follows a sequence of hydroprocessing chemical reactions starting with reaction section one (R1). R1 includes two sets of reactions that proceed in series: Hydrolysis 202 and Hydrogenation 204. First, Hydrolysis reacts SMR Hydrogen with the Feed Triglycerides 206 to form Unsaturated Fatty Acids (USFA) and Propane Fuel Product. Hydrogenation follows Hydrolysis and saturates the Unsaturated Fatty Acids with SMR Hydrogen to form Saturated Fatty Acids (SFA).

Reaction section two (R2) follows R1 to start a Deoxygenation Pathway 208. R2 includes three sets of deoxygenation reactions that occur in parallel; Decarbonylation (DCN) 210, Decarboxylation (DCO) 212, and Hydrodeoxygenation (HDO) 214. The molar percentage use of each reaction pathway is specified in the System Inputs. SMR Hydrogen is used in the DCN and HDO pathways to produce Heavy Alkanes and Byproducts. The DCO pathway proceeds without SMR Hydrogen and also produces Heavy Alkanes and Byproducts.

Reaction section three (R3) follows R2 and initiates a Hydrocracking Reaction 216. R3 includes the Hydrocracking and Isomerization reactions 218, 220, and 222. Hydrocracking reacts Heavy Alkanes with SMR Hydrogen to form lower molecular weight Fuel Products. Isomerization rearranges carbon chains in the Fuel Products to achieve improved physical properties of the Fuel Products and consumes no SMR Hydrogen.

The Hydrocracking Reaction Extent is specified in the System Inputs and is a measure of the R3 Heavy Alkane feed that is converted into lower molecular weight Fuel Products. Expressed as a molar percent of the Heavy Alkane feed, a higher extent implies a higher percentage of conversion to lighter Fuel Products (Propane, Naphtha, and Kerosine).

Propane Hydrocracking is also specified in the System Inputs and determines the molar percentage of the Heavy Alkane feed that is hydrocracked to Propane Fuel Product. The remaining Heavy Alkanes that are hydrocracked from Naphtha and Kerosine Fuel Products.

The Fuel Products Yields 224 are determined by separating the R3 reaction products based on the RD or SAF Operating Mode 226 specified in the System Inputs including Component Properties 228 and Chemical Reaction Equation Coefficients 230. An RD Operating Mode separates the R3 reaction products into Propane, Naphtha, and Diesel (RD) Fuel Products. An SAF Operating Mode separates the R3 reaction products into Propane, Naphtha, Kerosine (SAF), and Diesel (RD) Fuel Products.

Finally, the quantities of SMR Hydrogen required to complete the hydroprocessing reactions in R1, R2, and R3 are combined to determine the total SMR Hydrogen Demand 234.

TABLE 2

| Process | Description | Output |
|---|---|---|
| Hydrolysis | Conversion of Triglycerides into | Propane |
| (R1) | Unsaturated Fatty Acids | Palmitic Acid |
| | | Palmitoleic Acid |
| | | Stearic Acid |
| | | Oleic Acid |
| | | Linoleic Acid |
| | | Linolenic Acid |
| Hydrogenation | Hydrogenation of Unsaturated Fatty | Palmitic Acid |
| (R1) | Acids to form Saturated Fatty Acids | Stearic Acid |
| Deoxygenation | Chemical conversion of Saturated Fatty | Pentadecane |
| (R2) | Acids into Heavy Alkanes using the | Hexadecane |
| | HDO, DCO, and DCN reaction pathways | Heptadecane |
| | | Octadecane |
| | | Water, CO2, & CO Byproducts |
| Hydrocracking and | Cracking reaction to convert Heavy | Propane |
| Isomerization (R3) | Alkanes to Fuel Products | Naphtha |
| | Isomerization reaction to improve Fuel | Kerosine (SAF) |
| | Product physical properties | Diesel (RD) |
| Reaction Equations | Chemical Reaction Coefficient | Reaction Equation Coefficients |
| | Generation | |

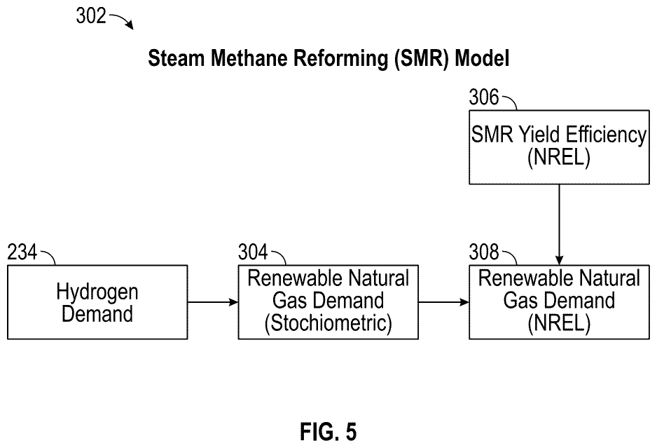

The SMR Hydrogen Demand 234 generated by the Hydroprocessing Model 104 is produced using a Steam Methane Reforming (SMR) process 302 illustrated in FIG. 5 and supported with information in Table 3. Renewable Natural Gas (RNG) is reacted with steam over reforming catalyst to form SMR Hydrogen and carbon dioxide. The Hydrogen Production Model first generates the stochiometric amount of Renewable Natural Gas 304 needed to yield the SMR Hydrogen Demand. A typical “real world” hydrogen yield efficiency factor 306 from data generated by the National Renewable Energy Lab (NREL) is applied to the stochiometric amount of RNG. The application of this efficiency factor results in a more conservative RNG feed quantity 308 required to generate the SMR Hydrogen Demand.

TABLE 3

| Process | Description | Output |
|---|---|---|
| Steam Methane | Conversion of Renewable Natural | Stochiometric |
| Reforming | Gas and Water into Hydrogen at the | Renewable Natural Gas |
| (Stochiometric Yield) | theoretical maximum conversion | Demand |
| | level | |
| NREL 2019 GREET | Conversion of Renewable Natural | Typical (NREL) |
| Model Hydrogen | Gas and Water into Hydrogen at a | Renewable Natural Gas |
| Production Update | typical industry yield efficiency as | Demand |
| | determined by NREL in 2019 for | |
| | use in the GREET Model | |

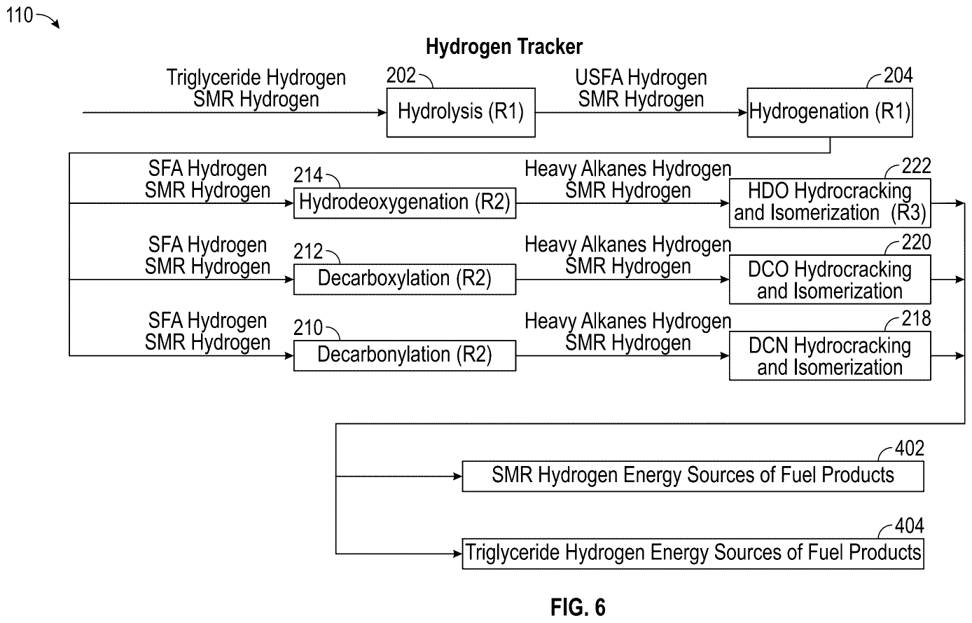

The Hydrogen Tracker 110, illustrated in FIGS. 6-8 with supporting information in Table 4, is a hydrogen accounting model at the center of the Credit Generation Algorithm 100 as it identifies and tracks the quantity of hydrogen sourced by RNG (SMR Hydrogen) and by the Triglyceride Feed (Triglyceride Hydrogen) that is used to form the Fuel Products. It is critical to differentiate the SMR Hydrogen from the Triglyceride Hydrogen in the Fuel Products as the SMR Hydrogen (manufactured using RNG) is the only hydrogen source that can generate a specific type of environmental attribute credit (cellulose based).

FIG. 6 illustrates the SMR Hydrogen and Triglyceride Hydrogen flows as they are processed through the sequence of hydroprocessing chemical reactions in R1 (202, 204), R2 (210, 212, 214), and R3 (218, 220, 222). After R3, the reaction products are separated into the Fuel Products (Propane, Naphtha, Kerosine, and Diesel) and Byproducts (Water and Methane). The Hydrogen Tracker calculates the quantity of SMR Hydrogen 402 and Triglyceride Hydrogen 404 in each of these Fuel Products and Byproducts. The mathematical model is constructed using the same general flow pattern illustrated in FIG. 6.

TABLE 4

| Element | Description | Output |
|---|---|---|
| Hydrolysis & | Triglyceride and SMR Sourced Hydrogen are | Hydrogen Sources of |
| Hydrogenation | tracked through the formation of Fatty Acids | Saturated Fatty Acid Input to |
| (R1) | and Propane | R2 and |
| | | Propane Product |
| Deoxygenation | Triglyceride and SMR Sourced Hydrogen from | Hydrogen Sources of Heavy |
| (R2) | R1 plus R2 SMR Sourced Hydrogen tracked | Alkanes Input to R3 and |
| | through the formation of Heavy Alkanes | Byproducts |
| Hydrocracking and | Triglyceride and SMR Sourced Hydrogen from | Hydrogen Sources of Fuel |
| Isomerization (R3) | R1 and R2 plus R3 SMR Sourced Hydrogen | Products |
| | tracked through the formation of Fuel Products | |
| Triglyceride and | Separate Molar, Weight, and Energy Balances | Check for Closed Balances |
| SMR Hydrogen | for Triglyceride and SMR Sourced Hydrogen | |
| Balances | | |

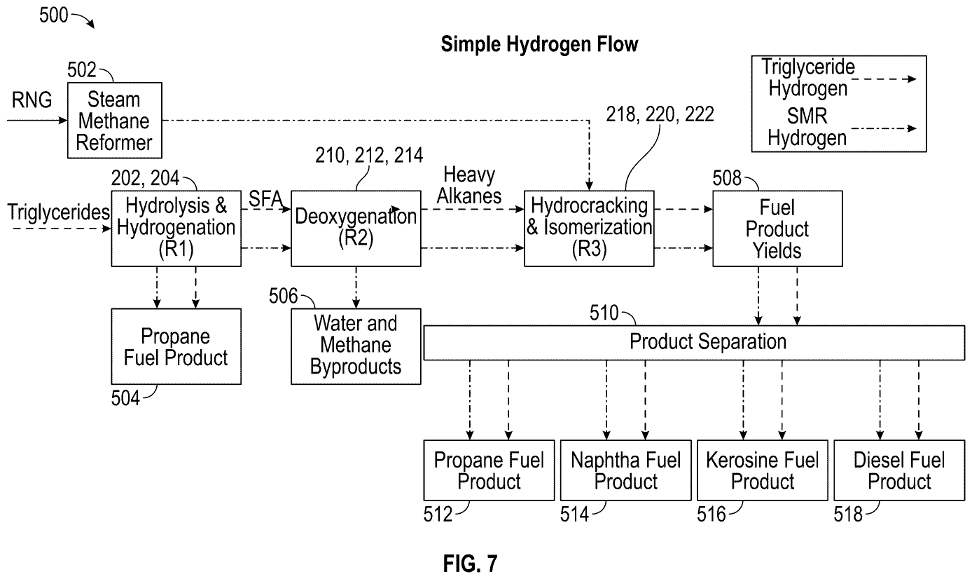

FIG. 7 adds some important detail to the Hydrogen Tracker 110 process flow 500. Specifically, the SMR Hydrogen from the Steam Methane Reformer 502 and Triglyceride Hydrogen follow different flow patterns through R1 (202, 204), R2 (210, 212, 214), and R3 (218, 220, 222). All of the Triglyceride Hydrogen enters the system in R1 and then flows through R2 and R3 in series. The SMR Hydrogen is supplied to R1, R2, and R3 in parallel. The different flow patterns through the three reaction sections (Triglyceride Hydrogen in series and SMR Hydrogen in parallel) adds significant complexity to the tracking of the hydrogen sources and uses. Also shown in FIG. 7 is the formation of Propane Fuel Product 504 in R1, Water and Methane Byproducts 506 in R2, and Fuel Product Yields 508 that through Product Separation 510 result in Propane 512, Naphtha 514, Kerosine 516, and Diesel 518 Fuel Products.

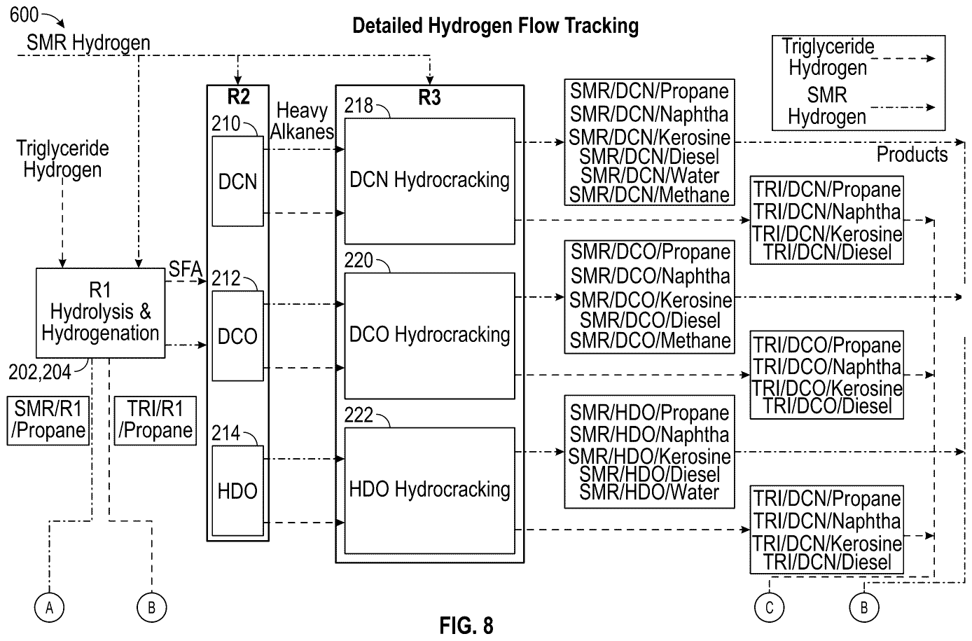

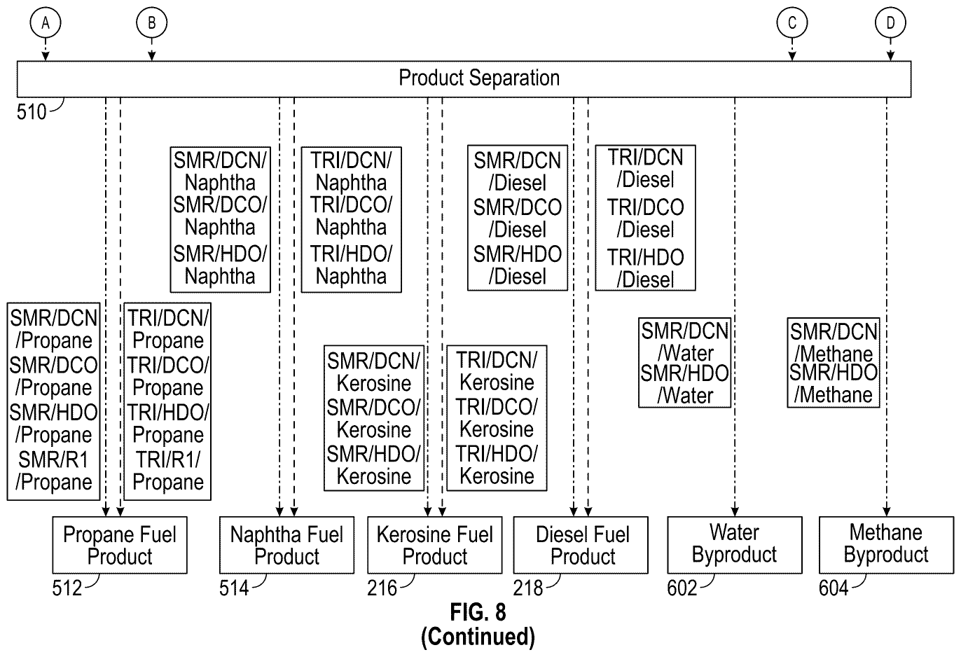

FIG. 8 provides a detailed description of each hydrogen stream as they flow from R3 through a separation step to yield the Fuel Products. Twenty-eight hydrogen streams have unique identifiers that include the hydrogen source (SMR or Triglyceride), R2 reaction pathway (DCN, DCO, HDO), and product (Propane 512, Naphtha 514, Kerosine 516, Diesel 518, Water 602, Methane 604).

For example, SMR Hydrogen that follows the HDO pathway to form Kerosine is identified as SMR/HDO/Kerosine. Similarly, Triglyceride Hydrogen that follows the DCO pathway and forms Propane is identified as TRI/DCO/Propane.

An additional two hydrogen streams have unique identifiers that include the hydrogen source (SMR or Triglyceride), R1 reaction pathway (R1), and product (Propane), The combination of the twenty-eight unique hydrogen streams from R3 with the two unique hydrogen streams from R1 yield a total of thirty unique hydrogen streams that are accounted for in the Hydrogen Tracker.

These thirty unique hydrogen streams are tracked from source to product in the Hydrogen Tracker, however, only the SMR Hydrogen that forms Fuel Products can generate cellulose based environmental attribute credits.

Also, separate molar, weight, and energy balances for the SMR Hydrogen and Triglyceride Hydrogen streams are calculated from source to product in the Hydrogen Tracker. These balances provide a check that all of the System Input material and energy is accounted for in the Fuel Products and Byproducts.

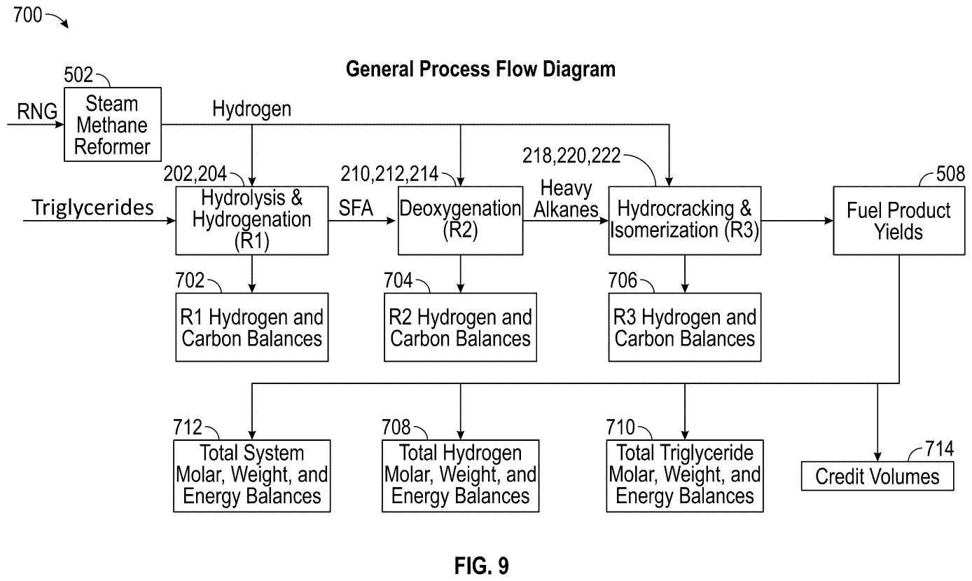

The General Process Flow Diagram, illustrated in FIG. 9 with supporting information in Table 5, was developed to check the molar, weight, and energy balances 702, 704, 706 of each of the three sequential steps of the hydroprocessing chemical reaction process. Once the balances are calculated, the integration of the SMR Hydrogen content of the Fuel Products (from the Hydrogen Tracker) allows for the calculation of the quantity of cellulose based environmental attribute credits for each Fuel Product.

The General Process Flow Diagram contains bulk molar, weight, and energy balances for each reaction section (R1, R2, and R3).

SMR Hydrogen 708 and Triglyceride 710 molar, weight, and energy balances for each reaction section are also calculated. These balances provide a check that all of the system input material and energy is accounted for in each reaction section as well as the entire hydroprocessing chemical reaction process 712.

The SMR Hydrogen and Triglyceride energy sources for the Fuel Products from R3 are calculated and used to determine the energy contribution percentage of the SMR Hydrogen. The SMR Hydrogen energy content of the Fuel Products is used to calculate the quantity of cellulosic based environmental attribute credits 714 for each Fuel Product.

TABLE 5

| Element | Description | Output |
|---|---|---|
| Steam Methane | SMR Molar, Weight & | Hydrogen Supply to R1, |
| Reformer (SMR) | Energy Balances | R2, and R3 |
| Hydrolysis & | R1 Molar & Weight | Propane Yield |
| Hydrogenation (R1) | Balances | Saturated Fatty Acid Input |
| | Hydrogen and | to R2 |
| | Triglyceride Weight & | |
| | Energy Balances | |
| Deoxygenation (R2) | R2 Molar & Weight | Heavy Alkane Input to R3 |
| | Balances | CO, CO2, H2O, and CH4 |
| | Hydrogen and | Byproduct Yields |
| | Triglyceride Weight & | |
| | Energy Balances | |
| Hydrocracking and | R3 Molar & Weight | Total Fuel Product Yields |
| Isomerization (R3) | Balances | |
| | Hydrogen and | |
| | Triglyceride Weight & | |
| | Energy Balances | |
| R1, R2, R3, and Total | Separate Molar, Weight, | Check for Closed |
| System Balances | and Energy Balances for | Balances |
| | R1, R2, R3, and Total | |
| | System | |
| SMR Hydrogen | R1, R2, and R3 SMR | Check for Closed |
| Balance | Hydrogen Molar, Weight, | Balances |
| | and Energy Balances | |
| Triglyceride Balance | R1, R2, and R3 | Check for Closed |
| | Triglyceride Molar, | Balances |
| | Weight, and Energy | |
| | Balances | |
| Credit Generation | Determination of SMR | Credit Volumes |
| | Hydrogen Energy | |
| | Content of Fuel Products | |

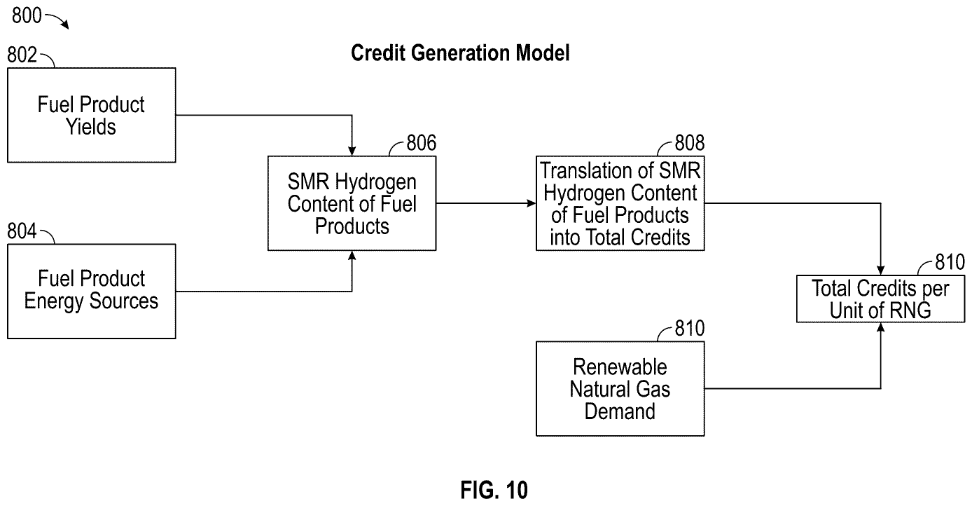

The Credit Generation Model 800, illustrated in the schematic in FIG. 10 supported with information in Table 6, was developed to gather all of the data required to calculate the environmental attribute credits in one model.

Fuel Product yields 802 and energy sources 804 are used to determine the SMR Hydrogen energy content 806 of each of the fuel products. The SMR Hydrogen energy content and the volume of each Fuel Product are used to calculate the quantity and type of environmental attribute credits 808.

Finally, the ratio of the quantity of the cellulosic based environmental attribute credits and the energy content of the RNG 810 used to produce the SMR Hydrogen is calculated to determine the total system efficiency in generating this specific credit type from RNG 812.

TABLE 6

| Element | Description | Output |
|---|---|---|
| Fuel Product Yields | Calculation of the | Fuel Product Weights and Volumes |
| | Weight and Volume of | |
| | Each Fuel Product | |
| Hydrogen and | Calculation of the | SMR Hydrogen and RNG Weights and |
| Renewable Natural | Weight and Energy | Energy Content |
| Gas Demands | Content of the SMR | |
| | Hydrogen and | |
| | Renewable Natural Gas | |
| | Demands | |
| Fuel Product Energy | Calculation of the SMR | Percent Contribution of SMR |
| Sources | Hydrogen and | Hydrogen and Triglyceride Energy |
| | Triglyceride Energy | Sources for Fuel Products |
| | Sources for Fuel | |
| | Products | |
| Credit Generation | Translation of SMR | Credit Volumes by Fuel Product |
| | Hydrogen Energy | |
| | Content of Products | |
| | into Credit | |

The development of reaction step and system level molar, weight, and energy balances is required to provide confidence that all System Inputs are properly accounted for through each step of the hydroprocessing chemical reaction and product separation processes.

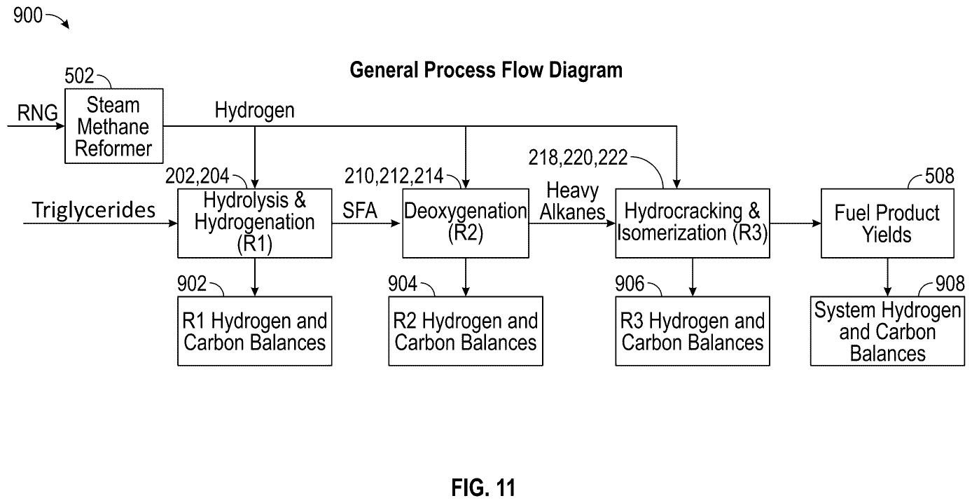

The System Carbon and Hydrogen balances are illustrated in FIG. 11 with supporting information in Table 7 and account for the carbon and hydrogen inputs on a molecular level for R1 (902), R2 (904), R3 (906), and the Total System (908).

TABLE 7

| Process | Description | Output |
|---|---|---|
| Carbon Balance | Carbon molecule tracking | System Carbon |
| | through R1, R2, and R3 | Balance Check |
| Hydrogen | Hydrogen molecule tracking | System Hydrogen |
| Balance | through R1, R2, and R3 | Balance Check |

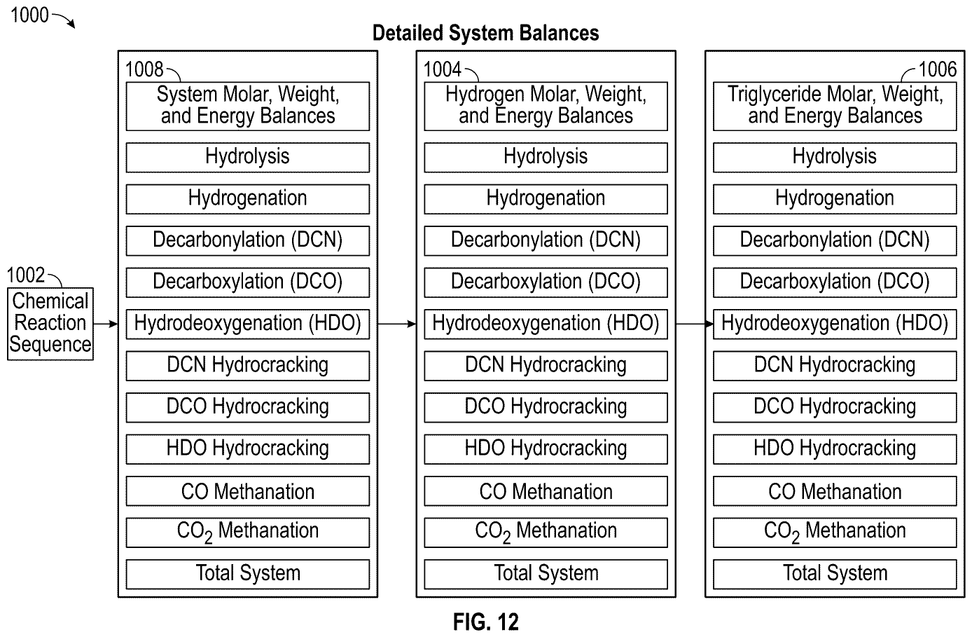

The Detailed System Balances are illustrated FIG. 12 with supporting information in Table 8 and contain a matrix of molar, weight, and energy balances (a set of balances) separately for SMR Hydrogen, Triglycerides, and the Total System and by each step of the hydroprocessing chemical reaction process 1002. There are ten sets of balances for each step in the system plus one set of balances for the Total System. These eleven sets of balances are calculated for three inputs (SMR Hydrogen 1004, Triglycerides 1006, Total Inputs 1008) for a total of thirty-three sets of balances.

TABLE 8

| Process | Description | Output |
|---|---|---|
| Chemical | Sequence of Reactions based on | Complete and |
| Reaction | Coefficients Generated by the | Balanced System |
| Sequence | Hydroprocessing Model | Chemical Reaction |
| | | Equations |
| SMR | Reaction Pathway Specific | System SMR |
| Hydrogen | Molar, Weight, and Energy | Hydrogen Balance |
| System | Balances for all SMR Hydrogen | Check |
| Balances | | |
| Triglyceride | Reaction Pathway Specific | System Triglyceride |
| System | Molar, Weight, and Energy | Balance Check |
| Balances | Balances for Triglyceride | |
| | Sourced Intermediates and Fuel | |
| | Products | |
| Total System | Reaction Pathway Specific | Total Combined |
| Balances | Molar, Weight, and Energy | System Balance |
| | Balances for the Total Combined | Check |
| | System | |

### EXAMPLES

Embodiments of the present invention are further illustrated by the following prophetic examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Production of Renewable Diesel, Naphtha and Propane from Renewable Natural Gas and Soybean Oil

In this example, a renewable fuel composition in accordance with an embodiment of this invention is made.
Step 1. Soybean oil (SBO) is fed into a hydroprocessor at the volume shown in Table 9. This data is fed into the model to determine the ratio of moles of hydrogen per mole of soybean oil required by the Renewable Diesel unit in order to complete the necessary chemical reactions. Correspondingly, this model represents the steam methane reformer hydrogen production required and the corresponding amount of methane feed. The soybean oil feed content is shown in Table 10 and provides the mole % of tripalmitin, tripalmitolein, stearin, triolein, linolein, and triliolenin present.

Chemical reactions are broken into three sections (R1, R2, and R3), which represent three steps in the reaction sequence at a Renewable Diesel manufacturing facility:
R1—Triglyceride Hydrolysis and Fatty Acid Saturation
R2—Hydrodeoxygenation
R3—Isomerization and Hydrocracking

Note that other reactions such as decarboxylation, decarbonylation, and methanation may also be employed, however, are not included in this example 1.

Table 11 shows the reaction equations for each reactor (USFA is unsaturated fatty acid, SFA is saturated fatty acid, and HDO is hydrodeoxygenation).

TABLE 9

| | Basis |
|---|---|
| 1,000,000 | gallons Soybean Oil Feed |
| 7.66 | lb/gallon SBO |
| 7,660,000 | lbs SBO Feed |
| 872.22 | lb/lb-mol SBO |
| 8782.17 | lb-mol SBO |
| 17.050 | lb-mols Total H2/lb-mollb-mol Triglyceride |
| 149,740 | lb-mols Total H2 Production |

TABLE 10
Vegetable Oil Content

| | mole % |
|---|---|
| 16:0 | 12.3% |
| 16:1 | 0.1% |
| 18:0 | 4.0% |
| 18:1 | 21.8% |
| 18:2 | 54.2% |
| 18:3 | 7.7% |
| | 100.0% |

*Vegetable oil for this pathway is governed by the feedstock content of soybean oil, sourced from multiple feedstock composition sources, including the USDA, Howard & Forsyth, and Cavalcanti, et. al. which all display values in a similar range. The Lipid Handbook values were chosen for this prototype. For more details, see feed content tab.

TABLE 11

| | | | | | | | | | |
|---|---|---|---|---|---|---|---|---|---|
| Hydrolysis | 1 | SBO+ | 3 | H2 | → | 3 | USFA+ | 1 | Propane |
| Saturation | 3 | USFA+ | 4.600446394 | H2 | → | 3 | SFA | | |
| HDO | 3 | SFA+ | 9 | H2 | → | 3 | Alkane+ | 6 | H2O |
| Cracking | 3 | Alkane+ | 0.45 | H2 | → | .90 | Naphtha+ | 2.55 | Diesel |

| | | | | | | | | | | | | | |
|---|---|---|---|---|---|---|---|---|---|---|---|---|---|
| System | 1 | SBO+ | 17.05044639 | H2 | → | 1 | Propane+ | 6 | H2O+ | 0.90 | Naphtha+ | 2.55 | Diesel |

Step 2. The demand for cellulosic hydrogen is taken from Step 1 and converted as shown in Table 4 to relative molecular weight (lb-mol). The SMR stoichiometry is utilized to determine how many lb-mol of natural gas and water are needed to produce this much hydrogen.

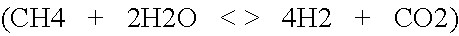

Step 3. Utilizing the lower heating value of natural gas, as provided by GREET (in BTU/lb), the model, as shown in Table 4, converts the mass yield values to energy yield (MMBtu). This yield assumes no losses and is theoretical. Optionally, LHV of natural gas from 40 CFR 80.1426(f)(7)(vi)(Q) may be used but utilizing the GREET NG-LHV yields more conservative RNG volumes.
Step 4. Utilizing a facility-specific yield efficiency, the actual quantity of natural gas feedstock energy necessary to produce each MMBtu of hydrogen is calculated as shown in Table 12. This is the “SMR Ratio.”

TABLE 12
General SMR Model
Steam Methane Reforming

| Reactants (lb-mol) | | Products (lb-mol) | |
|---|---|---|---|
| R-CH4 | H20 | R-H2 | CO2 |
| 37,435 | 74,870 | 149,740 | 37,435 |

Basis: 149,740 lb-mollb-mols H2 Production

| | | | SMR Stochiometric Yield | | | | | | |
|---|---|---|---|---|---|---|---|---|---|
| | | | | lb-mollb- | | | | SMR Actual Yield | |
| LHV | GREET | RFS Reg | | mols | lbs | BTU/lb | MMBTU | Efficiency | MMBTU |
| R-CH4 | 20,286 | 19,700 | R-CH4 | 37,435 | 600,569 | 20286 | 12,183 | 94.5% | 12,890 |
| | Selector for | GREET | R-H2 | 149,740 | 301,876 | 51631 | 15,586 | | 15,586 |
| | NG-LHV to be | | | | | | | | |
| | applied: | | | | | | | | |
| CH4 Yield | 94.5% | Percent | | | | Yield | 1.279 | Yield | 1.209 |
| Efficiency | | | | | | | | | |

| facility-specific, theoretical placeholder is | SMR Ratio | 0.827 |
|---|---|---|
| selected to align with the SMR ratio outlined | (MMBtu CH4/H2) | |
| in the 2019 GREET H2 update. | | |

General SMR Model
Steam Methane Reforming

| Reactants | | Products | |
|---|---|---|---|
| R-CH4 | H20 | R-H2 | CO2 |
| 39,902 | 79,804 | 159,607 | 39,902 |

Basis: 159,607 lb-mollb-mols H2 Production

| | | | SMR Stochiometric Yield | | | | | | |
|---|---|---|---|---|---|---|---|---|---|
| | | | | lb-mollb- | | | | SMR Actual Yield | |
| LHV | GREET | RFS Reg | | mols | lbs | BTU/lb | MMBTU | Efficiency | MMBTU |
| R-CH4 | 20,286 | 19,700 | R-CH4 | 39,902 | 640,145 | 20286 | 12,986 | 94.5% | 13,742 |
| | Selector for | GREET | R-H2 | 159,607 | 321,769 | 51631 | 16,613 | | 16,613 |
| | NG-LHV to be | | | | | | | | |
| | applied: | | | | | | | | |
| CH4 Yield | 94.5% | Percent | | | | Yield | 1.279 | Yield | 1.209 |
| Efficiency | | | | | | | | | |

| | | |
|---|---|---|
| facility-specific, theoretical placeholder is | SMR Ratio | 0.827 |
| selected to align with the SMR ratio outlined | (MMBtu CH4/H2) | |
| in the 2019 GREET H2 update. | | |

### Step 5. Hydrolysis and Saturation.

In this step, the triglycerides provided by the soybean oil undergo hydrolysis (with the hydrogen) to yield unsaturated fatty acids and propane fuel product. The following are achieved in this step of the model and shown in Table 13:
Determination of the MMBtus of hydrogen that is embedded into the propane transportation fuel. After displacement with RNG, this is used for RIN propane generation directly.
Determination of the MMBtus of hydrogen that is embedded into the unsaturated fatty acids (“USFA”), which is an input to the saturation step.
A mass and energy balance for the hydrolysis and saturation reactions (for both H2 and triglycerides respectively) is established for model robustness.

Following completion of the hydrolysis reactions, additional hydrogen is reacted with the unsaturated fatty acids to form saturated fatty acids. The model quantifies the total amount of hydrogen in the saturated fatty acids, which is an input to subsequent reactions modeled.

The energy balance is tracked through this chemical reaction in the same manner as during hydrolysis above.

TABLE 13
Hydroprocessing R1 (Hydrolysis & Saturation)
Hydrolysis

| | | lb-mols | lb | MMBTU |
|---|---|---|---|---|
| Inputs | SBO | 8,782 | 7,660,000 | 130,220 |
| | SMR H2 | 26,347 | 53,115 | 2,742 |
| | Total | 35,129 | 7,713,115 | 132,962 |
| Outputs | USFA | 26,347 | 7,323,012 | 125,459 |
| | Propane | 8,782 | 387,267 | 7,503 |
| | Total | 35,129 | 7,710,279 | 132,962 |

SMR H2 Balance

| | | | | |
|---|---|---|---|---|
| Input | SMR H2 | 26,347 | 53,115 | 2,742 |
| Output | USFA SMR H2 | 13,173 | 26,557 | 1,371 |
| | Propane SMR | | | |
| | H2 | 13,173 | 26,557 | 1,371 |
| | Total SMR H2 | 26,347 | 53,115 | 2,742 |

Triglyceride Balance

| | | | | |
|---|---|---|---|---|
| Input | SBO | 8,782 | 7,660,000 | 130,220 |
| Output | USFA | 26,251 | 7,296,455 | 124,088 |
| | Propane | 8,180 | 360,710 | 6,132 |
| | Total | 34,431 | 7,657,165 | 130,220 |

Saturation

| | | lb-mols | lb | MMBTU |
|---|---|---|---|---|
| Inputs | USFA | 26,347 | 7,323,012 | 125,459 |
| | SMR H2 | 40,402 | 81,450 | 4,205 |
| | Total | 66,748 | 7,404,462 | 129,664 |
| Outputs | SFA | 26,347 | 7,403,632 | 129,664 |

SMR H2 Balance

| | | | | |
|---|---|---|---|---|
| Input | USFA SMR H2 | 13,173 | 26,557 | 1,371 |
| | SMR H2 | 40,402 | 81,450 | 4,205 |
| | Total SMR H2 | 53,575 | 108,008 | 5,577 |
| Output | SFA SMR H2 | 53,575 | 108,008 | 5,577 |

Triglyceride Balance

| | | | | |
|---|---|---|---|---|
| Input | USFA | 26,251 | 7,296,455 | 124,088 |
| Output | SFA | 26,347 | 7,295,625 | 124,088 |

Step 6. Hydrodeoxygenation. Following the saturation reaction, additional hydroprocessing is done on the saturated fatty acids formed in step 5. Alkanes are produced through hydrodeoxygenation (HDO), as well as water as a coproduct. These alkanes are the precursors of what is to become the transportation fuels of diesel and naphtha. As shown in Table 14, the key outputs of this modeling step are the MMBtus of hydrogen leaving R2 in the form of alkanes and water loss. Energy and mass balances in R2 are also tracked at an aggregate system level.

TABLE 14
Hydroprocessing R2 (Hydrodeoxygenation)

| | | |
|---|---|---|
| lb-mols | lb | MMBTU |

System Balance

| | | | | |
|---|---|---|---|---|
| Inputs | SFA | 26,347 | 7,403,632 | 129,664 |
| | SMR H2 | 79,040 | 159,344 | 8,227 |
| | Total | 105,386 | 7,562,976 | 137,892 |
| Outputs | Alkanes | 26,347 | 6,613,764 | 118,014 |
| | H20 | 52,693 | 949,265 | 19,816 |
| | Total | 79,040 | 7,563,029 | 137,830 |

SMR H2 Balance

| | | | | |
|---|---|---|---|---|
| Inputs | SFA SMR H2 | 53,575 | 108,008 | 5,577 |
| | SMR H2 | 79,040 | 159,344 | 8,227 |
| | Total H2 | 132,615 | 267,351 | 13,804 |
| Outputs | Alkanes SMR H2 | 79,922 | 161,122 | 8,319 |
| | H20 SMR H2 | 52,693 | 106,229 | 5,485 |
| | Total SMR H2 | 132,615 | 267,351 | 13,804 |

Triglyceride Balance

| | | | | |
|---|---|---|---|---|
| Inputs | SFA | 26,347 | 7,295,625 | 124,088 |
| Outputs | Alkanes | 26,347 | 6,452,642 | 109,695 |
| | H20 | 52,693 | 843,036 | 14,332 |
| | Total | 79,040 | 7,295,678 | 124,027 |

Step 7. Hydrocracking. As shown in Table 15, the final step of transportation fuel production is hydrocracking. In this set of reactions, longer carbon chain molecules are broken into shorter chains to produce renewable diesel and naphtha.

TABLE 15
Hydroprocessing R3 (Hydrocracking)

| | | |
|---|---|---|
| lb-mols | lb | MMBTU |

System Balance

| | | | | |
|---|---|---|---|---|
| Inputs | SFA | 26,347 | 6,613,764 | 118,014 |
| | SMR H2 | 3,952 | 7,967 | 411 |
| | Total | 30,298 | 6,621,731 | 118,425 |
| Outputs | Naphtha | 7,904 | 1,000,008 | 18,113 |
| | Diesel | 22,395 | 5,621,699 | 100,312 |
| | Total | 30,298 | 6,621,708 | 118,425 |

SMR H2 Balance

| | | | | |
|---|---|---|---|---|
| Inputs | Alkanes | 79,922 | 161,122 | 8,319 |
| | SMR H2 | | | |
| | SMR H2 | 3,952 | 7,967 | 411 |
| | Total | 83,874 | 169,089 | 8,730 |
| | SMR H2 | | | |
| Outputs | Naphtha | 15,940 | 32,135 | 1,659 |
| | SMR H2 | | | |
| | Diesel | 67,933 | 136,954 | 7,071 |
| | SMR H2 | | | |
| | Total | 83,874 | 169,089 | 8,730 |
| | SMR H2 | | | |

Triglyceride Balance

| | | | | |
|---|---|---|---|---|
| Inputs | Alkanes | 26,347 | 6,452,642 | 109,695 |
| Outputs | Naphtha | 7,904 | 967,873 | 16,454 |
| | Diesel | 22,395 | 5,484,746 | 93,241 |
| | Total | 30,298 | 6,452,618 | 109,695 |

Step 8. As shown in Table 16, to generate RINs for each product, the energy content derived from the hydrogen is traced through the three reaction sections and recorded as a percentage of the entire energy content of that product. The volume eligible for cellulosic RIN generation is calculated using the total volume (Vs) of fuel produced and the energy ratio of cellulosic hydrogen in the fuel (FER/(FER+FENR).

VRIN is then calculated for each fuel by multiplying the applicable equivalence value by Vs. Note that the equivalence values applied are validated against GREET LHV calculations.

In this section, we show the maximum number of cellulosic RINs that may be generated through natural gas displacement via RNG. Actual RIN generation will be determined by the RNG used by the renewable fuels production facility in the batching period, as shown below.

TABLE 16
RIN Generation

| | MMBTU | % |
|---|---|---|
| Propane | | |
| Max RNG | 1,134 | |
| Displacement | | |
| SMR H2 | 1,371 | 18.3% |
| Triglyceride | 6,132 | 81.7% |
| Total | 7,503 | |
| lbs | 387,267 | |
| gallons | 94,031 | |
| gallons from | 17,184 | |
| SMR H2 | | |
| Equivalency | 1.1 | |
| Value | | |
| D3 RINS | 18,902 | |
| Naphtha | | |
| Max RNG | 1,372 | |
| Displacement | | |
| SMR H2 | 1,659 | 9.16% |
| Triglyceride | 16,454 | 90.84% |
| Total | 18,113 | |
| lbs | 1,000,008 | |
| gallons | 167,096 | |
| gallons from | 15,306 | |
| SMR H2 | | |
| Equivalency | 1.5 | |
| Value | | |
| D3 RINS | 22,960 | |
| Diesel | | |
| Max RNG | 5,848 | |
| Displacement | | |
| SMR H2 | 7,071 | 7.0% |
| Triglyceride | 93,241 | 93.0% |
| Total | 100,312 | |
| lbs | 5,621,699 | |
| gallons | 866,912 | |
| gallons from | 61,109 | |
| SMR H2 | | |
| Equivalency | 1.7 | |
| Value | | |
| D3 RINS | 103,886 | |

### Step 9.

This section translates the modeling above into a RIN generation process, as described hereinbelow and shown in Table 17. The key operational data points to be monitored for cellulosic RIN generation and the specific calculations to be performed for VRIN calculation are identified. The main steps are as follows:
The operational efficiency of the hydrogen production units in the batching period are quantified, on an aggregate basis, not specific to RNG-to-hydrogen production. This is captured 10 in the “SMR Ratio BTU RNG/BTU H2” parameter.
Volume/mass as well as analytical data of the renewable fuels production facility's triglyceride and hydrogen feed in the period is collected and used in our model to calculate the batch-specific “H2 Apportionment”. This apportionment describes the % of hydrogen embedded into the outputs of the renewable fuels production facility, on an energy basis, irrespective of whether the hydrogen is of cellulosic origins.
The “H2 Apportionment” modeling results are used to determine the total volume of each fuel that is derived from hydrogen.
Based on RNG use in the batching period (supported by the quantity of RNG-D3 RINs retired by the renewable diesel producer), the gallons of cellulosic propane, naphtha and renewable diesel are calculated based on what proportion of the natural gas feed for hydrogen production was displaced with RNG. In our pathway, only feedstock for hydrogen that is embedded into the propane, naphtha or diesel fuels is displaced with RNG.
With the gallons of cellulosic fuel types established, the appropriate equivalence values are used to calculate cellulosic RIN volumes for each.

TABLE 17
RIN Generation Protocol - Data Collected & Vrin Calculations

| Facility-Specific Inputs | | “Live data” from facility | | Laboratory Analysis | |
|---|---|---|---|---|---|
| Triglyceride feed (gal) | 1,000,000 | H2 output fm SMR | 301,876 | SBO Density | 7.66 lb/gallon |
| RNG Input in SMR (MMBtu) | 8,354 | (metered, lbs) | | H2 LHV | 51,631 Btu/lb (R&D GREET 2023 default) |
| SMR Ratio BTU RNG/BTU H2 | 0.827 | Propane Volume (gal) | 94,031 | | |
| | | Nap Volume (gal) | 167,096 | | |
| | | Diesel Volume (gal) | 866,912 | | |

| H2 Apportionment | | Triglyceride Apportionment | | | | | |
|---|---|---|---|---|---|---|---|
| | energy % | | energy % | Model-Derived Factors | | | |
| Water | 35.2% | Water | 11.0% | 6,132 | MMBtu of Trigly. Propane | 1,371 | MMBtu of H2-derived Propane |
| Propane | 8.8% | Propane | 4.7% | 16,454 | MMBtu of Trigly. Naphtha | 1,659 | MMBtu of H2-derived Naphtha |
| Naphtha | 10.6% | Naphtha | 12.6% | 93,241 | MMBtu of Trigly. Diesel | 7,071 | MMBtu of H2-derived Diesel |
| Diesel | 45.4% | Diesel | 71.6% | | | | |
| Total | 100.0% | Total | 100.0% | | | | |

Vᵣᵢₙ Calculations

| Gallons of Fuel Derived from hydrogen | | Volume of Cellulosic Fuel | Equivalence Value (RINs/gal) | D3/7 RINs Generated | RINs/MMBtu RNG |
|---|---|---|---|---|---|
| 17,184 | gal (Propane) | 17,184 | 1.1 | 18,902 | 2.26 |
| 15,306 | gal (Naphtha) | 15,306 | 1.5 | 22,960 | 2.75 |
| 61,109 | gal (Diesel) | 61,109 | 1.7 | 103,886 | 12.44 |
| | | | | 145,747 | 17.45 |

Laboratory Analysis

| | BTU/Gal (LHV)* | |
|---|---|---|
| Propane | 84,250 | |
| Heavy Naphtha | 116920 | |
| Diesel | 128450 | |
| Ethanol | 77000 | |
| SBO LHV | 17,000 | Btu/lb |
| SBO MW | 872 | lb/lb-mol |
| Propane Density | 4.12 | lb/gallon |
| Naphtha Density | 5.98 | lb/gallon |
| Diesel Density | 6.48 | lb/gallon |

In support of the foregoing calculations, the molecular weights used are shown in Table 18, the SMR mass balance is shown in Table 19, the yield efficiency is shown in Table 20, the energy balances in Table 21, and the product equivalence value in Table 22.

TABLE 18

| | Carbon | Hydrogen | Oxygen | MW |
|---|---|---|---|---|
| | 12.011 | 1.008 | 15.999 | lb/lb-mol |
| CH4 | 1 | 4 | 0 | 16.043 |
| H20 | 0 | 2 | 1 | 18.015 |
| H2 | 0 | 2 | 0 | 2.016 |
| CO2 | 1 | 0 | 2 | 44.009 |

TABLE 19

| | lb-mols | lb/lb-mol | lbs | wt % |
|---|---|---|---|---|
| Inputs | | | | |
| R—CH4 | 39,902 | 16.04 | 640,145 | 31% |
| H20 | 79,804 | 18.02 | 1,437,664 | 69% |
| Total In | 119,706 | | 2,077,809 | |
| Outputs | | | | |
| R—H2 | 159,607 | 2.02 | 321,769 | 15% |
| CO2 | 39,902 | 44.01 | 1,756,041 | 85% |
| Total Out | 199,509 | | 2,077,809 | |

TABLE 20
Check on Yield Efficiency

| | | |
|---|---|---|
| Stoch Yield | 1.279 | MMBTU H2/MMBTU Stoch CH4 |
| Actual Yield | 1.209 | MMBTU H2/MMBTU Actual CH4 |
| Yield Efficiency | 94.5% | Stoch MMBTU CH4/Actual MMBTU CH4 |

TABLE 21

| Feed Based Constants | | | SOURCE | |
|---|---|---|---|---|
| SBO Density | 7.66 | lb/gallon | Engineering | |
| SBO MW | 872 | lb/lb-mol | Toolbox | |
| SBO Energy Content | 17,000 | BTU/lb | Calculated in full model | |
| SMR H2 MW | 2.016 | lb/lb-mol | EPA RFS Rule 80.1426 (f)(7)(vi)(C) | |
| SMR H2 Energy Content | 51631 | BTU/lb | Calculated above | |
| USFA MW | 278 | lb/lb-mol | R&D GREET 2023 | |
| SFA MW | 281 | lb/lb-mol | Calculated in full model | |
| Alkanes MW | 251 | | Calculated in full model | |
| Naphtha MW | 127 | | | |
| Diesel MW | 251 | | | |
| Product Based Constants | | | | |
| Propane Density | 4.12 | lb/gallon | Engineering | Calculated from the kg/m3 value shown |
| | | | Toolbox | in the Engineer Toolbox |
| Naphtha Density | 5.98 | lb/gallon | Engineering | <- based on weighted averages of component densities |
| | | | Toolbox | of various chemical forms of naphtha |
| Diesel Density | 6.48 | lb/gallon | Engineering | <- based on weighted averages of component densities |
| Constants | | | Toolbox | of various chemical forms of diesel |
| Propane MW | 44.1 | lb/lb-mol | Calculated in full model | |
| Water MW | 18.0 | lb/lb-mol | Calculated in full model | |

SMR Actual Yield
Energy Balance

| | LHV | |
|---|---|---|
| | [MMBtu] | Balance |
| Inputs | | |
| R-CH4 | 13,742 | |
| H2O | 0 | |
| Total In | 13,742 | |
| Outputs | | |
| R-H2 | 16,613 | |
| CO2 | 0 | |
| Total Out | 16,613 | 2,871 |
| | | 21% |

| Hydrocracker Energy Balance - Cellulosic | | | | Hydrocracker Energy | | | |
|---|---|---|---|---|---|---|---|
| portion of fuel only | | | | Balance - Overall | | | |
| | LHV | Balance | Balance | | LHV | Balance | Balance |
| | [MMBtu] | 1 | 2 | | [MMBtu] | 1 | 2 |
| Inputs | | | | Inputs | | | |
| VGO | 0 | | | VGO | 203,345 | | |
| H2 | 16,613 | | | H2 | 16,613 | | |
| Total In | 16,613 | | | Total In | 219,958 | | |
| Outputs | | | | Outputs | | | |
| Butane | 550 | | | Butane | 9,772 | | |
| C5-180 F | | | | C5-180 | | | |
| Lt Nap | 1,561 | | | F Lt Nap | 24,725 | | |
| 180 + F Hvy | | | | 180 + F | | | |
| Nap | 2,525 | | | Hvy Nap | 36,093 | | |
| Diesel | 11,734 | | | Diesel | 145,393 | | |
| Total Out | 16,370 | −243 | 2,629 | Total | 215,984 | −3,975 | 1,103 |
| | | −1.5% | 19.1% | Out | | −1.8% | 0.51% |

TABLE 22
Product Equivalence Value (EqV)

| | BTU/Gal | EQ |
|---|---|---|
| | (LHV)* | Factor |
| Propane | 84,250 | 1.094 |
| Heavy Naphtha | 116920 | 1.518 |
| Diesel | 128450 | 1.668 |
| Ethanol | 77000 | 1.000 |
| Butane | 94970 | 1.233 |
| C5-180 F. Lt Nap | 105125 | 1.365 |
| 180+ F. Hvy Nap | 116920 | 1.518 |
| Diesel | 128450 | 1.668 |
| Ethanol | 77,000 | 1.000 |

*LHV from 2023 GREET

### Example 2—Production of Sustainable Aviation Fuel and Renewable Diesel, Naphtha and Propane from Renewable Natural Gas and Soybean Oil

In this example, a renewable fuel composition in accordance with an embodiment of this invention is made.
Step 1. Soybean oil (SBO) is fed into a hydroprocessor at the volume shown in Table 23. This data is fed into the model to determine the ratio of moles of hydrogen per mole of soybean oil required by the hydroprocessing unit in order to complete the necessary chemical reactions. Correspondingly, this model represents the steam methane reformer hydrogen production required and the corresponding amount of renewable natural gas feed. The soybean oil feed content is shown in Table 24 and provides the mole % of tripalmitin, tripalmitolein, stearin, triolein, linolein, and triliolenin present.

Chemical reactions are broken into three sections (R1, R2, and R3), which represent three steps in the reaction sequence at a sustainable aviation fuel manufacturing facility:
R1—Triglyceride Hydrolysis and Fatty Acid Saturation
R2—Dexoygenation (hydrodeoxygenation, decarboxylation, and decarbonylation reactions are all listed for completeness. However, the decarbonylation reaction is not utilized in this representative case.
R3—Isomerization and Hydrocracking
RM Methanation—Methanation reactions are not utilized in this representative case, those reactions are included for illustration.

Table 25 shows the reaction equations for each reactor (DCN is decarbonylation, DCO is decarboxylation, HDO is hydrodeoygenation, USFA is unsaturated fatty acid, SFA is saturated fatty acid, and HDO is hydrodeoxygenation).

TABLE 23
Basis

| | |
|---|---|
| 1,000,000 | gallons Soybean Oil Feed |
| 7.66 | lb/gallon SBO |
| 7,656,385 | lbs SBO Feed |
| 871.81 | lb/lb-mol SBO |
| 8782.17 | lb-mol SBO |
| 16.1504 | lb-mols Total H2/Lb-molLb-mol |
| | Triglyceride |
| 141,836 | Ib-mols Total H2 Production |

TABLE 24
Vegetable Oil Content

| | mole % |
|---|---|
| 16:0 | 12.3% |
| 16:1 | 0.1% |
| 18:0 | 4.0% |
| 18:1 | 21.8% |
| 18:2 | 54.2% |
| 18:3 | 7.7% |
| | 100.0% |

*Vegetable oil for this pathway is governed by the feedstock content of soybean oil, sourced from multiple feedstock composition sources, including the USDA, Howard & Forsyth, and Cavalcanti, et. al. which all display values in a similar range. The Lipid Handbook values were chosen for this prototype. For more details, see feed content tab.

TABLE 25

| | | | | | | | | | | | | | |
|---|---|---|---|---|---|---|---|---|---|---|---|---|---|
| R1 | Hydrolysis | 1 | SBO+ | 3.00 | H2 → | 3.00 | USFA+ | 1.00 | Propane | | | | |
| R1 | Saturation | 3.00 | USFA+ | 4.60045 | H2 → | 3.00 | SFA | | | | | | |
| | DCN | 0.00 | SFA+ | 0.00 | H2 → | 0.00 | Alkanes+ | 0.00 | CO+ | 0.00 | H2O | | |
| R2 | DCO | 0.75 | SFA | 0.00 | H2 → | 0.75 | Alkanes+ | 0.75 | CO2 | | | | |
| R2 | HDO | 2.25 | SFA+ | 6.75 | H2 → | 2.25 | Alkanes+ | 4.50 | H2O | | | | |
| | DCN Cracking | 0.00 | Alkanes+ | 0.00 | H2 → | 0.00 | Propane+ | 0.00 | Naphtha+ | 0.00 | kerosine+ | 0.00 | Diesel |
| R3 | DCO Cracking | 0.75 | Alkanes+ | 0.75 | H2 → | 0.0225 | Propane+ | 0.42 | Naphtha+ | 0.50 | kerosine+ | 0.26 | Diesel |
| R3 | HDO Cracking | 2.25 | Alkanes+ | | H2 → | 0.0675 | Propane+ | 0.27 | Naphtha+ | 2.47 | kerosine+ | 0.79 | Diesel |
| | CO Methanation | 0.00 | CO+ | | H2 → | 0.00 | CH4+ | 0.00 | H2O+ | 0.00 | CO | | |
| RM | CO2 Methanation | 0.75 | CO2 | | H2 → | 0.00 | CH4+ | 0.00 | H2O+ | 0.75 | CO2 | | |
| | System | 1 | SBO+ | | H2 → | 1.090 | Propane+ | 0.69 | Naphtha+ | 2.97 | kerosine+ | 1.05 | Diesel+ |
| | | | | | | 0.00 | CH4+ | 4.50 | H2O+ | 0.00 | CO+ | 0.75 | CO2 |

Step 2. The demand for cellulosic hydrogen is taken from Step 1 and converted as shown in Table 18 to relative molecular weight (lb-mol). The SMR stoichiometry is utilized to determine how many lb-mol of natural gas and water are needed to produce this much hydrogen.

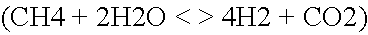

Step 3. Utilizing the lower heating value of natural gas, as provided by GREET (in BTU/lb), the model, as shown in Table 26, converts the mass yield values to energy yield (MMBtu). This yield assumes no losses and is theoretical. Optionally, LHV of natural gas from 40 CFR 80.1426(f)(7)(vi)(Q) may be used but utilizing the GREET NG-LHV yields more conservative RNG volumes.
Step 4. Utilizing a facility-specific yield efficiency, the actual yield of energy from the natural gas is calculated.

TABLE 26
General SMR Model
Steam Methane Reforming

| | |
|---|---|
| Reactants (lb-mol) | Products (lb-mol) |

| | | | |
|---|---|---|---|
| R-CH4 | H2O | R-H2 | CO2 |
| 35,459 | 70,918 | 141,836 | 35,459 |

Basis: 141.836 lb-mols H2 Production

| | LHV | GREET | RFS Reg |
|---|---|---|---|
| | R-Ch4 | 20,286 | 19,700 |
| Selector for NG-LHV to be applied: | | | GREET |
| | CH4 Yield Efficiency: | 94.5% | Percent |

facility-specific, theoretical placeholder is
select to align with the SMR ratio outlined
in the 2019 GREET H2 update.
SMR Stochiometric Yield

| | lb-mollb- | | |
|---|---|---|---|
| | mols | lbs | BTU/lb |
| R-CH4 | 35,459 | 568,868 | 20,286 |
| R-H2 | 141,836 | 285,941 | 51,631 |
| | | | Yield |

SMR Actual Yield

| MMBTU | Efficiency | MMBTU |
|---|---|---|
| 11,540 | 94.5% | 12,209 |
| 14,763 | | 14,763 |
| 1.279 | Yield | 1.209 |

| | |
|---|---|
| SMR Ratio (MMBtu CH4/H2 | 0.827 |

### Step 5. Hydrolysis and Saturation.

In this step, the triglycerides provided by the soybean oil undergo hydrolysis (with the hydrogen) to yield unsaturated fatty acids and propane fuel product. The following are achieved in this step of the model and shown in Table 27:
Determination of the MMBtus of hydrogen that is embedded into the propane transportation fuel. After displacement with RNG, this is used for RIN propane generation directly.
Determination of the MMBtus of hydrogen that is embedded into the unsaturated fatty acids (“USFA”), which is an input to the saturation step.
A mass and energy balance for the hydrolysis and saturation reactions (for both H2 and triglycerides respectively) is established for model robustness.

Following completion of the hydrolysis reactions, additional hydrogen is reacted with the unsaturated fatty acids to form saturated fatty acids. The model quantifies the total amount of hydrogen in the saturated fatty acids, which is an input to subsequent reactions modeled.

The energy balance is tracked through this chemical reaction in the same manner as during hydrolysis above.

TABLE 27
Hydroprocessing R1 (Hydrolysis & Saturation)
Hydrolysis

| | | lb-mols | lb | MMBTU |
|---|---|---|---|---|
| Inputs | SBO | 8,782 | 7,656,385 | 130,159 |
| | SMR H2 | 26,347 | 53,115 | 2,742 |
| | Total | 35,129 | 7,709,500 | 132,901 |
| Outputs | USFA | 26,347 | 7,322,232 | 125,398 |
| | Propane | 8,782 | 387,267 | 7,503 |
| | Total | 35,129 | 7,709,500 | 132,901 |

SMR H2 Balance

| | | | | |
|---|---|---|---|---|
| Input | SMR H2 | 26,347 | 53,115 | 2,742 |
| Output | USFA SMR H2 | 13,173 | 26,557 | 1,371 |
| | Propane SMR H2 | 13,173 | 26,557 | 1,371 |
| | Total SMR H2 | 26,347 | 53,115 | 2,742 |

Triglyceride Balance

| | | | | |
|---|---|---|---|---|
| Input | SBO | 8,782 | 7,656,385 | 130,159 |
| Output | USFA | 26,251 | 7,295,675 | 124,026 |
| | Propane | 8,180 | 360,710 | 6,132 |
| | Total | 34,431 | 7,656,385 | 130,159 |

Saturation

| | | lb-mols | lb | MMBTU |
|---|---|---|---|---|
| Inputs | USFA | 26,347 | 7,322,232 | 125,398 |
| | SMR H2 | 40,402 | 81,450 | 4,205 |
| | Total | 66,748 | 7,403,682 | 129,603 |
| Outputs | SFA | 26,347 | 7,403,682 | 129,603 |

SMR H2 Balance

| | | | | |
|---|---|---|---|---|
| Input | USFA SMR H2 | 13,173 | 26,557 | 1,371 |
| | SMR H2 | 40,402 | 81,450 | 4,205 |
| | Total SMR H2 | 53,575 | 108,008 | 5,577 |
| Output | SFA SMR H2 | 53,575 | 108,008 | 5,577 |

Triglyceride Balance

| | | | | |
|---|---|---|---|---|
| Input | USFA | 26,251 | 7,295,675 | 124,026 |
| Output | SFA | 26,347 | 7,295,675 | 124,026 |

Step 6. Deoxygenation. Following the saturation reaction, additional processing is done on the saturated fatty acids formed in step 5 in the form of deoxygenation. Deoxygenation has three discrete pathways, hydrodeoxygenation (HDO), decarbonylation (DCN), decarboxylation (DCO). In this Example 2, the model depicts deoxygenation using two of the pathways. Specifically, 75% of the SFA are processed through HDO and 25% through DCO.
Step 6a. Hydrodeoxygenation. In this step, heavy alkanes are produced through hydrodeoxygenation (HDO), as well as water byproduct. The heavy alkanes are the precursors of what is to become transportation fuel products, such as kerosine (SAF), diesel (RD), and naphtha. As shown in Table 28, the key outputs of this modeling step are the MMBtus of hydrogen leaving R2 in the form of alkanes and water byproduct. Energy and mass balances in R2 are also tracked at an aggregate system level.

R2a (Hydrodeoxygenation)

| | | |
|---|---|---|
| lb-mols | lb | MMBTU |

System Balance

| | | | | |
|---|---|---|---|---|
| Inputs | SFA | 19,760 | 5,552,754 | 97,202 |
| | SMR H2 | 59,280 | 119,508 | 6,170 |
| | Total | 79,039 | 5,672,262 | 103,372 |
| Outputs | Alkanes | 19,760 | 4,960,314 | 88,510 |
| | H20 | 39,520 | 711,948 | 14,862 |
| | Total | 59,280 | 5,672,262 | 103,372 |

SMR H2 Balance

| | | | | |
|---|---|---|---|---|
| Inputs | SFA SMR H2 | 40,181 | 81,006 | 4,182 |
| | SMR H2 | 59,280 | 119,508 | 6,170 |
| | Total H2 | 99,461 | 200,513 | 10,353 |
| Outputs | Alkanes SMR | 59,941 | 120,841 | 6,239 |
| | H2 | | | |
| | H20 SMR H2 | 39,520 | 79,672 | 4,114 |
| | Total SMR H2 | 99,461 | 200,513 | 10,353 |

Triglyceride Balance

| | | | | |
|---|---|---|---|---|
| Inputs | SFA | 19,472 | 5,471,749 | 93,020 |
| Outputs | Alkanes | 19,278 | 4,839,473 | 82,271 |
| | H20 | 35,097 | 632,276 | 10,749 |
| | Total | 54,376 | 5,471,749 | 93,020 |

Step 6b. Decarboxylation (DCO). Additionally, heavy alkanes are also produced through decarboxylation (DCO), as well as CO2 byproduct. The heavy alkanes are the precursors of what is to become transportation fuel products, such as kerosine (SAF), diesel (RD), and naphtha. As shown in Table 29, the key outputs of this modeling step are the MMBtus of hydrogen leaving R2 in the form of alkanes.

Energy and mass balances in R2 are also tracked at an aggregate system level.

TABLE 29
R2b (decarboxylation)

| | | |
|---|---|---|
| lb-mols | lb | MMBTU |

System Balance

| | | | | |
|---|---|---|---|---|
| Inputs | SFA | 6,587 | 1,850,921 | 32,401 |
| | SMR | | | |
| | H2 | 0 | 0 | 0 |
| | Total | 6,587 | 1,850,921 | 32,401 |
| Outputs | Alkanes | 6,587 | 1,561,050 | 27,473 |
| | CO2 | 6,587 | 289,871 | 4,928 |
| | Total | 13,173 | 1,850,921 | 32,401 |

SMR H2 Balance

| | | | | |
|---|---|---|---|---|
| Inputs | SFA SMR H2 | 13,394 | 27,002 | 1,394 |
| | SMR H2 | 0 | 0 | 0 |
| | Total H2 | 13,394 | 27,002 | 1,394 |
| Outputs | Alkanes SMR H2 | 13,394 | 27,002 | 1,394 |
| | CO2 | 0 | 0 | 0 |
| | Total SMR H2 | 13,394 | 27,002 | 1,394 |

Triglyceride Balance

| | | | | |
|---|---|---|---|---|
| Inputs | SFA | 6,491 | 1,823,919 | 31,007 |
| Outputs | Alkanes | 6,473 | 1,534,048 | 26,079 |
| | CO2 | 6587 | 289,871 | 4928 |
| | Total | 13,059 | 1,823,919 | 31,007 |

Step 7. Hydrocracking & Isomerization. Hydrocracking is the chemical process which reduces the molecular weight of the heavy alkanes by breaking the carbon chains. This results in lighter alkanes, which are separated into various products. The isomerization process is leveraged to alter the fuel products characteristics in order to achieve required physical properties.
Step 7a. Hydrocracking—Hydrodeoxygenation (HDO). The final step of transportation fuel production is hydrocracking. In this set of reactions, longer carbon chain molecules are broken into shorter chains to produce kerosine, diesel, naphtha, and propane. Specifically, the alkane feed going into the hydrocracker from HDO are the even numbered alkanes hexadecane (C16) & octadecane (C18). This is shown in Table 30.

TABLE 30
Hydroprocessing R3 (Hydrocracking from HDO)

| | | |
|---|---|---|
| lb-mols | lb | MMBTU |

System Balance

| | | | | |
|---|---|---|---|---|
| Inputs | Alkanes | 19,760 | 4,960,314 | 88,510 |
| | SMR H2 | 11,856 | 23,902 | 1,234 |
| | Total | 31,616 | 4,984,216 | 89,744 |
| Outputs | Propane | 593 | 26141 | 489 |
| | Naphtha | 2,370 | 270,703 | 4919 |
| | Kerosine | 21727.4983 | 2,924,765 | 52892 |
| | Diesel | 6,926 | 1,762,608 | 31445 |
| | Total | 31,616 | 4,984,216 | 89,744 |

SMR H2 Balance

| | | | | |
|---|---|---|---|---|
| Inputs | Alkanes SMR H2 | 59,941 | 120,841 | 6,239 |
| | SMR H2 | 11,856 | 23,902 | 1,234 |
| | Total SMR H2 | 71,797 | 144,743 | 7,473 |
| Outputs | Propane SMR H2 | 632 | 1,274 | 66 |
| | Naphtha SMR H2 | 4,541 | 9,155 | 473 |
| | Kerosine SMR H2 | 45418.1898 | 91,563 | 4,727 |
| | Diesel SMR H2 | 21205 | 42,750 | 2,207 |
| | Total SMR H2 | 71,797 | 144,743 | 4,473 |

Triglyceride Balance

| | | | | |
|---|---|---|---|---|
| Inputs | Alkanes | 19,278 | 4,839,473 | 82271 |
| Outputs | Propane | 564 | 24,866 | 423 |
| | Naphtha | 2,290 | 261,547 | 4446 |
| | Kerosine | 21,047 | 2,833,202 | 48164 |
| | Diesel | 6,758 | 1,719,858 | 29238 |
| | Total | 30,659 | 4,839,473 | 82,271 |

Step 7b. Hydrocracking—Decarboxylation (DCO). The final step of transportation fuel production is hydrocracking. In this set of reactions, longer carbon chain molecules are broken into shorter chains to produce diesel and naphtha. Specifically, the alkane feed going into the hydrocracker from DCO are the odd-numbered alkanes pentadecane (C15) & heptadecane (C17). This is shown in Table 31.

| | | |
|---|---|---|
| lb-mols | lb | MMBTU |

System Balance

| | | | | |
|---|---|---|---|---|
| Inputs | Alkanes | 6,587 | 1,561,050 | 27,473 |
| | SMR H2 | 3,952 | 7,967 | 411 |
| | Total | 10,539 | 1,569,017 | 27,884 |
| Outputs | Propane | 198 | 8714 | 161 |
| | Naphtha | 3,656 | 411,101 | 7,361 |
| | Kerosine | 4377 | 594,048 | 10,593 |
| | Diesel | 2,309 | 555,154 | 9,770 |
| | Total | 10,539 | 1,569,017 | 27,884 |

SMR H2 Balance

| | | | | |
|---|---|---|---|---|
| Inputs | Alkanes SMR H2 | 13,394 | 27,002 | 1,394 |
| | SMR H2 | 3,952 | 7,967 | 411 |
| | Total SMR H2 | 17,346 | 34,969 | 1,805 |
| Outputs | Propane SMR H2 | 178 | 359 | 19 |
| | Naphtha SMR H2 | 5,334 | 10,754 | 555 |
| | Kerosine SMR H2 | 7074 | 14,260 | 736 |
| | Diesel SMR H2 | 4760 | 9,596 | 495 |
| | Total SMR H2 | 17,346 | 34,969 | 1,805 |

Triglyceride Balance

| | | | | |
|---|---|---|---|---|
| Inputs | Alkanes | 6,473 | 1,534,048 | 26,079 |
| Outputs | Propane | 189 | 8355 | 142 |
| | Naphtha | 3,560 | 400,347 | 6806 |
| | Kerosine | 4271 | 579,788 | 9856 |
| | Diesel | 2,269 | 545,558 | 9274 |
| | Total | 10,290 | 1,534,048 | 26,079 |

Step 8. RIN Generation. As shown in Table 32, to generate RINs for each product, the energy content derived from the cellulosic hydrogen is traced through the three reaction sections and recorded as a percentage of the entire energy content of that product. The volume eligible for cellulosic RIN generation is calculated using the total volume (Vs) of fuel produced and the energy ratio cellulosic hydrogen in the fuel (FER/(FER+FENR). VRIN is then calculated for each fuel by multiplying the applicable equivalence value by Vs. Note that the equivalence values applied are validated against GREET LHV calculations. The total number of cellulosic RINs generated per MMBtu of RNG are also shown.

TABLE 32
RIN Generation

| | MMBTU | % |
|---|---|---|
| Propane | | |
| SMR H2 | 1,456 | 17.9% |
| Triglyceride | 6,697 | 82.1% |
| Total | 8,152 | |
| lbs | 422,121 | |
| gallons | 102,493 | |
| gallons from SM | 18,299 | |
| Equivalent | 1.1 | |
| D3 RINs | 20.129 | |
| Naphtha | | |
| SMR H2 | 1,028 | 8.37% |
| Triglyceride | 11,252 | 91.63% |
| Total | 12,280 | |
| lbs | 681,803 | |
| gallons | 116,309 | |
| gallons from SM | 9,736 | |
| Equivalent | 1.5 | |
| D3 RINs | 14.604 | |
| Kerosine | | |
| SMR H2 | 5,464 | 8.6% |
| Triglyceride | 58,021 | 91.4% |
| Total | 63,485 | |
| lbs | 3,518,814 | |
| gallons | 581,786 | |
| gallons from SM | 50,071 | |
| Equivalent | 1.6 | |
| D3 RINs | 80.114 | |
| Diesel | | |
| SMR H2 | 2,703 | 6.6% |
| Triglyceride | 38,512 | 93.4% |
| Total | 41,215 | |
| lbs | 2,317,762 | |
| gallons | 357,070 | |
| gallons from SM | 23,415 | |
| Equivalent | 1.7 | |
| D3 RINs | 39.806 | |

Step 9. RIN Calculations. This section translates modeling above into the RIN generation process described above. Key operational data points to be monitored for cellulosic RIN generation and the specific calculations to be performed for VRIN calculation are identified and shown in Table 33. The main steps are as follows:

TABLE 33
RIN Generation Protocol - Data Collected & Vrin Calculations

| Facility- | | | | | | | |
|---|---|---|---|---|---|---|---|
| Specific | | | | | | | |
| Inputs | | “Live data” from facility | | Laboratory Analysis | | | |
| Triglyceride | 1,000,000 | H2 output fm | 285,941 | | | | |
| feed (gal) | | SMR | | | | | |
| RNG Input in | 12,209 | (metered, lbs) | | | | | |
| SMR | | Propane | 102,493 | SBO Density | 7.656385 | lb/gallon | |
| (MMBtu) | | Volume (gal) | | | | | |
| SMR Ratio | 0.827 | Nap Volume | 116,309 | H2 LHV | 51,631 | Btu/lb | (R&D GREET 2023 |
| BTU | | (gal) | | | | | default) |
| RNG/BTU H2 | | Kerosine | 581,786 | | | | |
| | | Volume (gal) | | | | | |
| | | Diesel Volume | 357,070 | | | | |
| | | (gal) | | | | | |

| | | Triglyceride | | | | | |
|---|---|---|---|---|---|---|---|
| | | Apportionment | | | | | |
| H2 Apportionment | | | energy | | | | |
| | energy % | | % | Model-Derived Factors | | | |
| Water | 27.9% | Water | 8.3% | 6,697 | MMBtu of Trigly. Propane | 1,456 | MMBtu of H2- |
| Propane | 9.9% | Propane | 5.1% | | | | derived Propane |
| Naphtha | 7.0% | Naphtha | 8.6% | 11,252 | MMBtu of Trigly. Naphtha | 1,028 | MMBtu of H2- |
| Kerosine | 37.0% | Kerosine | 44.6% | | | | derived Naphtha |
| Diesel | 18.3% | Diesel | 29.6% | 58,021 | MMBtu of Trigly. Kerosine | 5,464 | MMBtu of H2- |
| Total | 100.0% | CO2 | 3.8% | | | | derived Kerosine |
| | | Total | 100.0% | 38,512 | MMBtu of Trigly. Diesel | 2,703 | MMBtu of H2- |
| | | | | | | | derived Diesel |

Vᵣᵢₙ Calculations

| Gallons of | | | | | |
|---|---|---|---|---|---|
| Fuel Derived | | | Equivalence | | |
| from | | | Value | D3/7 RINs | |
| Hydrogen | | Volume of Cellulosic Fuel | (RINs/gal) | Generated | RINs/MMBtu RNG |
| 18,299 | gal (Propane) | 18,299 | 1.1 | 20,129 | 1.65 |
| 9,736 | gal (Naphtha) | 9,736 | 1.5 | 14,604 | 1.20 |
| 50,071 | gal (Kerosine) | 50,071 | 1.6 | 80,114 | 6.56 |
| 23,415 | gal (Diesel) | 23,415 | 1.7 | 39,806 | 3.26 |
| | | | | 154,652 | 12.6667 |

The operational efficiency of the hydrogen production units in the batching period are quantified, on an aggregate basis, not specific to RNG-to-hydrogen production. This is captured in the “SMR Ratio BTU RNG/BTU H2” parameter.
   Volume/mass as well as analytical data of the renewable fuels production facility's triglyceride and hydrogen feed in the period is collected and used in our model to calculate the batch-specific “H2 Apportionment”. This apportionment describes the % of hydrogen embedded into the outputs of the renewable fuels production facility, on an energy basis, irrespective of whether the hydrogen is of cellulosic origins.
   The “H2 Apportionment” modeling results are used to determine the total volume of each fuel that is derived from hydrogen.
   Based on RNG use in the batching period (supported by the quantity of RNG-D3 RINs retired by the SAF producer), the gallons of cellulosic propane, naphtha, renewable diesel, and sustainable aircraft fuel are calculated based on what proportion of the natural gas feed for hydrogen production was displaced with RNG.
   With the gallons of cellulosic fuel types established, the appropriate equivalence values are used to calculate cellulosic RIN volumes for each.

In support of the foregoing calculations, the molecular weights used are shown in Table 34, the SMR mass balance is shown in Table 35, the yield efficiency is shown in Table 36, the feed and product-based constants in Table 37, and the product equivalence value in Table 38.

TABLE 34
Validation & Supplementary Calculations

| | Carbon | Hydrogen | Oxygen | MW |
|---|---|---|---|---|
| | 12.011 | 1.008 | 15.999 | lb/lb-mol |
| CH4 | 1 | 4 | 0 | 16.043 |
| H20 | 0 | 2 | 1 | 18.015 |
| H2 | 0 | 2 | 0 | 2.016 |
| CO | 1 | 0 | 1 | 28.01 |
| CO2 | 1 | 0 | 2 | 44.009 |

TABLE 35

| | lb-mols | lb/lb-mol | lbs | wt % |
|---|---|---|---|---|
| Inputs | | | | |
| R—CH4 | 35,459 | 16.04 | 568,868 | 31% |
| H20 | 70,918 | 18.02 | 1,277,587 | 69% |
| Total In | 106,377 | | 1,846,455 | |
| Outputs | | | | |
| R—H2 | 141,836 | 2.02 | 285,941 | 15% |
| CO2 | 35,459 | 44.01 | 1,560,514 | 85% |
| Total Out | 177,295 | | 1,846,455 | |

From Step 2's results, the weight balance of the SMR reaction is checked (in lbs) in column L.

TABLE 36
Check on Yield Efficiency

| | | |
|---|---|---|
| Stoch Yield | 1.279 | MMBTU H2/MMBTU Stoch CH4 |
| Actual Yield | 1.209 | MMBTU H2/MMBTU Actual CH4 |
| Yield Efficiency | 94.5% | Stoch MMBTU CH4/Actual MMBTU CH4 |

TABLE 37

SOURCE

Feed Based Constants

| | | | |
|---|---|---|---|
| SBO Density | 7.66 | lb/gallon | Engineering Toolbox |
| SBO MW | 872 | lb/lb-mol | Calculated in full model |
| SBO Energy Content | 17,000 | BTU/lb | EPA RFS Rule 80.1426 (f)(7)(vi)(C) |
| SMR H2 MW | 2.016 | lb/lb-mol | Calculated above |
| SMR H2 Energy Content | 51631 | BTU/lb | R&D GREET 2023 |
| USFA MW | 277.9204 | lb/lb-mol | Calculated in full model |
| SFA MW | 281.0119 | lb/lb-mol | Calculated in full model |
| DCN Alkanes MW | 237.0029 | lb/lb-mol | Calculated in full model |
| DCO Alkanes MW | 237.0029 | lb/lb-mol | Calculated in full model |
| HDO Alkanes MW | 251.0299 | lb/lb-mol | Calculated in full model |
| DCN Naphtha MW | 112.4492 | lb/lb-mol | Calculated in full model |
| DCO Naphtha MW | 112.4492 | lb/lb-mol | Calculated in full model |
| HDO Naphtha MW | 114.2320 | lb/lb-mol | Calculated in full model |
| DCN Kerosine MW | 135.7344 | lb/lb-mol | Calculated in full model |
| DCO Kerosine MW | 135.7344 | lb/lb-mol | Calculated in full model |
| HDO Kerosine MW | 134.6112 | lb/lb-mol | Calculated in full model |
| DCN Diesel MW | 240.4750 | lb/lb-mol | Calculated in full model |
| DCO Diesel MW | 240.4750 | lb/lb-mol | Calculated in full model |
| HDO Diesel MW | 254.5020 | lb/lb-mol | Calculated in full model |

Product Based Constants

| | | | | |
|---|---|---|---|---|
| Propane Density | 4.11852 | lb/gallon | Engineering Toolbox | calculated from the kg/m3 value |
| | | | | shown in the Engineering Toolbox |
| Naphtha Density | 5.86202 | lb/gallon | Engineering Toolbox | <− based on weighted averages |
| | | | | of the component densities of various |
| | | | | chemical form of naphtha |
| Kerosine Density | 6.04829 | lb/gallon | Engineering Toolbox | <− based on weighted averages |
| | | | | of component densities of various |
| | | | | chemical form of kerosine |
| Diesel Density | 6.49106 | lb/gallon | Engineering Toolbox | <− based on weighted averages |
| | | | | of component densities of various |
| | | | | chemical forms of diesel. |

Constants

| | | | |
|---|---|---|---|
| Propane MW | 44.1 | lb/lb-mol | Calculated in full model |
| Water MW | 18.0 | lb/lb-mol | Calculated in full model |

TABLE 38
Product Equivalence Value (EqV)

| | BTU/Gal (LHV)* | EQ Factor |
|---|---|---|
| Propane | 84,250 | 1.094 |
| Heavy Naphtha | 116,920 | 1.518 |
| Kerosine | 124,307 | 1.614 |
| Diesel | 128,450 | 1.668 |
| Ethanol | 77,000 | 1.000 |

*LHV from 2023 GREET

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When compositions, systems, or methods are claimed or described in terms of “comprising” various steps or components, the compositions, systems, or methods can also “consist essentially of” or “consist of” the various steps or components, unless stated otherwise.

The terms “a,” “an,” and “the” are intended to include plural alternatives, e.g., at least one. For instance, the disclosure of “a first monomer”, “a polymer composition”, and the like, is meant to encompass one, or mixtures or combinations of more than one first monomer, polymer composition, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate.

As used herein, the term “about” means plus or minus 10% of the numerical value of the number with which it is being used.

1. A method for producing one or more fuel credits, the method comprising the steps of:
providing low-carbon natural gas at a fuel production facility;
subjecting the low-carbon natural gas at the fuel production facility to a reforming process that produces low-carbon hydrogen;
combining the low-carbon hydrogen with triglyceride feedstock at the fuel production facility to form a mixture and causing a series of chemical reactions to occur in the mixture so as to produce one or more low-carbon fuels; and
generating or causing generation of one or more fuel credits including tracking the low-carbon natural gas through the step of producing the low-carbon hydrogen or tracking the low-carbon hydrogen through the step of producing the one or more low-carbon fuels or both.

2. The method of claim 1, wherein the low-carbon natural gas comprises renewable natural gas.

3. The method of claim 1, wherein the low-carbon natural gas comprises low-carbon fossil natural gas.

4. The method of claim 2, wherein the renewable natural gas is derived from biomass.

5. The method of claim 3, wherein the low-carbon fossil natural gas is fossil natural gas that incurs fewer greenhouse gas emissions throughout its collection, processing or transportation compared to traditional fossil natural gas and comprises geologic natural gas, CCS-enabled natural gas, diverted flared natural gas, or a combination thereof.

6. The method of claim 1, wherein the one or more low-carbon fuels produced comprise one or more biofuels or bioliquids.

7. The method of claim 1, wherein the one or more low-carbon fuels produced comprise renewable diesel.

8. The method of claim 1, wherein the one or more low-carbon fuels produced are one or more renewable fuels and comprise renewable diesel, naphtha, propane, or a combination thereof.

9. The method of claim 8, wherein the naphtha comprises light naphtha and heavy naphtha.

10. The method of claim 1, wherein the one or more low-carbon fuels produced comprise sustainable aviation fuel.

11. The method of claim 2, wherein the renewable natural gas is derived from biomass.

12. The method of claim 11, wherein the biomass is cellulosic comprising cellulose, hemi-cellulose, lignin, or a combination thereof.

13. The method of claim 1, wherein the triglyceride feedstock comprises vegetable oil, waste oil, used cooking oil, fat, or a combination thereof.

14. The method of claim 1, wherein the triglyceride feedstock comprises soybean oil.

15. The method of claim 1, wherein the reforming process is one of a steam methane reforming process or an autothermal reforming process.

16. The method of claim 1, wherein the series of chemical reactions includes hydrodeoxygenation, decarboxylation, or decarbonylation.

17. The method of claim 1, wherein the series of chemical reactions includes:
(a) hydrolysis and saturation; and
(b) hydrodeoxygenation, decarboxylation, or decarbonylation.

18. The method of claim 1, wherein the series of chemical reactions includes:
(a) hydrolysis and saturation;
(b) hydrodeoxygenation, decarboxylation, or decarbonylation; and
(c) hydrocracking.

19. The method of claim 18, wherein step (c) further comprises isomerization.

20. The method of claim 2, wherein the one or more low-carbon fuels are one or more renewable fuels, the low carbon hydrogen is renewable hydrogen, the step of producing the one or more renewable fuels produces a proportion of total renewable fuels derived from different renewable sources produced at the fuel production facility and the step of generating or causing generation of one or more fuel credits comprises tracking the renewable hydrogen through the step of producing the one or more renewable fuels and determining the proportion of the total renewable fuels derived from different renewable sources due to displacement of fossil natural gas with the renewable natural gas.

21. The method of claim 11, wherein the one or more low-carbon fuels are one or more renewable fuels, the low carbon hydrogen is renewable hydrogen, the step of producing the one or more renewable fuels produces a proportion of total renewable fuels derived from one or more types of biomass produced at the fuel production facility and the step of generating or causing generation of one or more fuel credits comprises tracking the renewable hydrogen through the step of producing the one or more renewable fuels and determining the proportion of the total renewable fuels derived from the one or more types of biomass due to displacement of fossil natural gas with the renewable natural gas.

22. The method of claim 1, wherein the step of generating or causing generation of a fuel credit comprises generating numerical information associated with the one or more fuel credits.

23. The method of claim 1, wherein the one or more fuel credits are enabled by any program that allows or employs incentives or avoids disincentives based on the quantification of low-carbon fuel production.

24. The method of claim 2, wherein the one or more fuel credits include a Renewable Identification Number (RIN).

25. The method of claim 2, wherein the one or more fuel credits includes a California Low Carbon Fuel Standard (LCFS) credit.

26. The method of claim 12, wherein the one or more low-carbon fuels produced from the renewable natural gas that is subjected to reforming are one or more renewable fuels and generates one or more RINs.

27. The method of claim 26, wherein generation of the one or more RINs is based on retirement of Cellulosic Biofuel RINs that are generated and assigned to renewable natural at production of the renewable natural gas that is subsequently subjected to reforming.

28. The method of claim 27, wherein the step of providing the renewable natural gas comprises delivering the renewable natural gas directly to the fuel production facility.

29. The method of claim 27, wherein the step of providing the renewable natural gas comprises providing a first quantity of natural gas to the renewable fuel production facility from a natural gas common carrier pipeline system which has received a second quantity of renewable natural gas from a renewable natural gas source remote from the renewable fuel production facility and the step of generating or causing generation of one or more fuel credits comprises attributing the second quantity of renewable natural gas to the first quantity of natural gas.

30. The method of claim 24, wherein producing the one or more low-carbon fuels are one or more renewable fuels and generates one or more cellulosic RINs.

31. The method of claim 8, wherein the low carbon hydrogen is renewable hydrogen, the fuel credit is a Renewable Identification Number (RIN), and producing the renewable diesel fuel, naphtha and butane with the renewable hydrogen generates one or more cellulosic RINs.

32. The method of claim 10, wherein the fuel credit is a Renewable Identification Number (RIN) and producing the sustainable aviation fuel generates one or more cellulosic RINs.

33. The method of claim 24, wherein the one or more low-carbon fuels are one or more renewable fuels and the number of RINs for every renewable fuel is calculated by determining the equivalence value used for each renewable fuel and the volume of each renewable fuel and multiplying the equivalence value used for each renewable fuel by the volume of each renewable fuel.

34. The method of claim 2, wherein the one or more low-carbon fuels are one or more renewable fuels, the low carbon hydrogen is renewable hydrogen, and for each of the one or more renewable fuels, the number of RINs is calculated as:
$${V}_{RIN , i} = {EqV}_{i} * {V}_{s , i}$$
wherein,
the steps of subjecting the renewable natural gas to reforming to produce renewable hydrogen and combining the renewable hydrogen with triglyceride feedstock at the fuel production facility to form a mixture and causing a series of chemical reactions to occur in the mixture so as to produce one or more renewable fuels occurs over a batching period;
i is each type of renewable fuel that RINs are generated for respective ones of the one of more renewable fuels;
V_{RIN,i} is the number RINs to be generated for each of the one or more renewable fuels;
EqVᵢ is the equivalence value used for each of the one or more renewable fuels; and
V_{s,i} is the volume of each of the one or more renewable fuels, calculated as follows:
$${V}_{s , i} = {V}_{H 2 - derived , gal , i} \times \frac{{RNG\_Used}_{MMBtu}}{SMR\_Ratio \times {H}_{2} \_to {\_RDF}_{MMBtu} \times {\%}_{H 2 toFuels}}$$
wherein,
RNG_Used_{MMBtu} is the RNG renewable natural gas provided and subjected to reforming to produce renewable hydrogen in the batching period, in MMBtu and as established through cellulosic RNG-RIN retirement;
SMR_Ratio is the overall MMBtu of the natural gas entering the reforming process divided by the overall MMBtu of hydrogen product leaving the reforming process used to produce renewable hydrogen for combining with the triglyceride feedstock in the fuel production facility, in the batching period;
H₂_to_RDF_{MMBtu} is the total MMBtu of hydrogen that was introduced to the fuel production facility in the batching period;
%_{H2toFuels} is a portion of the renewable hydrogen, measured as a percentage of H₂_to_RDF_{MMBtu}, that is embedded into the one or more renewable fuels;
V_{H2-derived,gal,i} is the gallons of each fuel derived from hydrogen, calculated as follows:
$${V}_{H 2 - derived , gal , i} = {Total\_vol}_{S , i} \times \frac{{MMBtu}_{H 2 - derived , i}}{{MMBtu}_{Trigly . - derived , i} + {MMBtu}_{H 2 - derived , i}}$$
Total_vol_{S,i} is the measured aggregate standardized volume at 60° F., in gallons, of each of the one of more renewable fuels i produced at the fuel production facility during the batching period;
MMBtu_{H2-derived,i} is the total energy content, on a lower heating value basis, of each of the one or more renewable fuels i produced by the fuel production facility during the batching period that is derived from the renewable hydrogen; and
MMBtu_{Trigly.-derived,i} is the total energy content, on a lower heating value basis, of each of the one or more renewable fuels i produced by the fuel production facility during the batching period that is derived from the triglyceride feedstock.

35. The method of claim 34, wherein values for %_{H2toFuels}, MMBtu_{H2-derived,i} and MMBtu_{Trigly.-derived,i} are established through tracking molecules of the renewable hydrogen throughout the steps of subjecting the renewable natural gas to the reforming process and producing one or more renewable fuels.

36. The method of claim 34, wherein a total quantity of natural gas is subjected to the reforming process and the renewable natural gas subjected to reforming is provided at a quantity that may be equal to or less than the total quantity of natural gas subjected to the reforming process.
